(19) United States
(12) Patent Application Publication
(10) Pub. No.: US 2010/0184488 A1
(43) Pub. Date: Jul. 22, 2010

(54) Sound signal adjuster adjusting the sound volume of a distal end voice signal responsively to proximal background noise

(75) Inventor: Masashi Takada, Yokohama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/654,639

(22) Filed: Dec. 28, 2009

(30) Foreign Application Priority Data
Jan. 16, 2009 (JP) 2009-008053

(51) Int. Cl. H04M 1/00

(52) U.S. Cl. 455/570

(57) ABSTRACT

In a sound signal adjuster for use in telephone circuitry including a microphone capturing sound to produce a first sound signal and a loudspeaker, a second sound signal representative of a sound in a vicinity of the loudspeaker is obtained, and transitions are detected in the first and second sound signals to determine whether or not the sound in the vicinity of the loudspeaker is blocked. When the blocking is detected, a difference is calculated between a first frequency characteristic detected in response to the sound captured by the loudspeaker being determined as blocked and a second frequency characteristic detected in response to the sound captured by the loudspeaker not being determined as blocked. The difference calculated is used for suppressing a noise component included in the first sound signal.

### BACKGROUND OF THE INVENTION

1. Field of the Invention

The present invention relates to telephone circuitry, and more particularly to a sound signal adjuster for use in telephone circuitry included advantageously in a telephone handset, such as a mobile phone. The present invention also relates to a method of implementing such a sound signal adjustment.

2. Description of the Background Art

Mobile telephone sets, for example, may often be used outdoors in nature for conveniently talking on the phone in the various environments the user is involved in. Furthermore, in general, such an environment may often be inferior in call or sound quality to conventional telephone subscriber sets even for outdoor use.

For example, mobile phone handsets may conventionally be used in naked in calls without staying in a telephone booth as with public phones. That makes the user annoyed with a possible background noise where he or she is involved in calls so that he or she is hard to listen to the voice transmitted from the distal end terminal connected. In such a circumstance, the user may often manipulate the keys or buttons disposed on the handset to raise the volume of receiver sound so as to more clearly listen to the distal end talker's voice.

The mobile telephone handsets tend to be more and more miniaturized and compact so that they are equipped with a majority of keys and buttons extremely on the front and side surfaces of the handset housing, thus making it more difficult to visually identify and confirm them during manipulation on the phone. That fact gives rise to inconveniences described below against proceeding to a smoother conversation on the phone.

It may often occur for the user on the phone to note the sound volume insufficient for listening after he or she actually began to talk. In order that the user raises the sound volume while involved in conversation on the phone, he or she has to manipulate an appropriate key or button of the handset. With the modern mobile phones thus designed so compact as stated above, it has now become more difficult for the user on the phone to grope for a key or button appropriate for volume control, as well as the recent tendency of increased keys and buttons due to multiple functions installed makes it more possible for the user on the phone to erroneously touch a key or button other than intended, thus causing the phone to operate in an unintended way.

If the user on the phone tries to visually find out such a volume control key, then he or she has to hand off the handset for a while, thus possibly missing or interrupting the conversation going on the phone unless he or she asks the distal end party for an interruption in advance. The distal end party, i.e. the person involved in the call on the distal end terminal, may not learn about whether such a missing or interruption is intentionally or physically caused, possibly harming the psychological relation therebetween.

In order to overcome the difficulties stated above, United States patent application publication No. US 2004/0259513 A1 to Park teaches a mobile phone terminal provided with a contact sensor in the vicinity of the loudspeaker for sensing the pressure applied when the user presses his or her ear thereon in order to automatically control the receiver sound volume in response to the pressure thus sensed, without manipulating a specific key or button therefor.

Japanese patent laid-open publication No. 241208/1989 to Morishita teaches a terminal unit having a microphone provided for sensing noise in the environment where the user uses it to render the sound volume of a received signal raised when the noise is remarkable.

Japanese patent laid-open publication No. 38624/1995 to Suzuki teaches a mobile phone terminal having an acoustic pressure sensor provided in a space formed between the loudspeaker and the part of the housing of the handset covering the loudspeaker, the pressure sensor being adapted to sense a change in acoustic pressure caused when the space is closed with an ear of the user. When the space is covered with the ear in contact so as to cause the acoustic pressure to increase, the control lowers the receiver sound volume, and otherwise raises the volume.

U.S. Pat. No. 6,760,453 B1 to Banno teaches a mobile terminal device adapted to control, when the user wishes to raise the sound volume and speaks louder, the sound volume of the loudspeaker to be raised.

Another United States patent application publication No. US 2008/0212753 A1 to Yoshizawa teaches a mobile phone terminal equipped with a camera provided on the same surface of the housing as the display screen disposed, the terminal being adapted for analyzing an image captured by the camera and determining, when black elements in the sensed image exceed a threshold, the housing being in contact with an ear of the user to allow the build-in loudspeaker to produce the received sound, and otherwise to allow a hand-free loudspeaker arranged separately from the mobile terminal to produce the received sound.

Another Japanese patent laid-open publication No. 2007-116585 to Tokuda teaches a noise canceller having the characteristics of surrounding noises stored in connection with the microphones, the noise characteristics thus stored being read out associated with selected one of the microphones to be used for frequency subtraction for noise suppression.

In practice, the conventional measures against background noises stated above involve the disadvantages that will be described below. The modern mobile phone handsets have become equipped with more and more functions and compact in size, thus requiring the users to sophisticate their manipulations on increased keys and buttons. That makes it more and more difficult to mount additional parts or elements such as sensors on the terminal units.

Park, indicated above, requires a pressure sensor to be mounted in the vicinity of the loudspeaker of a mobile phone handset, involving a difficulty in design for reserving its location.

Motishita stated above teaches that the microphone already built in a mobile terminal unit is utilized for sensing environmental noise to control the sound volume of a received signal accordingly without arranging an additional sensor. That control on the sound volume of a voice signal received from a distal end is dependent upon how the environmental noise is and not how the user wishes. For example, where the talker on the distal end speaks in a small voice, the above measure may not be effective on the listener listening on the phone even when the background noise is small.

Suzuki indicated above teaches the control on the sound volume of a voice signal transmitted from the distal end in response to the behavior of the listener at the proximal end on the phone. That solution however requires an additional pressure sensor to be arranged, as Park does. Moreover, it may be seldom in practice for the space to be covered with the ear in such a tight contact as to cause the acoustic pressure to increase, thus not being so effective as expected. In addition, when the listener is hard to listen to the distal end voice in an undertone, he or she is likely to press his or her ear hard on the loudspeaker, thus repetitively causing a deep contact of the ear with the pressure sensor to render the sound volume lower and lower.

Similarly, Banno teaches the control on the sound volume of a distal end voice signal in response to the behavior of the proximal end listener on the phone. Banno is more advantageous than Park, Morishita and Suzuki in that no additional sensors are required and the intention of the user may be reflected on the volume control without requiring any manipulations on the keys or buttons.

In Banno, however, in order to raise the sound volume of a received voice when the distal end talker speaks in a small voice, the proximal end talker has to speak louder even while the background noise is smaller at the proximal end. That may annoy people staying near the proximal end user, and thus often make the user hesitate to use such a volume control function.

The mobile terminal device disclosed by Banno is not adapted to distinguish background noise from conversational voice on the phone. Therefore, if background noise on the proximal end terminal is louder, the total sound signal on the proximal end is so high in level as to raise the sound volume of a distal end signal reproduced by the loudspeaker accordingly, thus being advantageous on one hand. On the other hand, however, the microphone of the mobile phone terminal catches the total sound including the voice of the talker together with the louder noise, so that the sound signal generated by the microphone has its electric power increased accordingly and will thus be transmitted in compliance with a predetermined transmission amplitude reference value. The listener on the distal end terminal will therefore feel still noisy.

Yoshizawa teaches a mobile phone terminal adapted for analyzing an image captured by the camera to thereby determine whether or not the housing is in contact with an ear of the user to switch the build-in loudspeaker or the hand-free loudspeaker arranged separately. In practice, however, a majority of mobile phone handsets are equipped with a camera built in on the side of the housing opposite to the display screen. That means the user being required, when wishing to control the sound volume of a distal end voice signal transmitted, for turning the handset backside front in order to control the sound volume on the phone, thus causing almost the same difficulties as manipulating the keys or buttons for sound volume control. Additionally, when using the mobile phone unit of Yoshizawa in, e.g. a dark room, the sound volume of a received distal end voice signal is unintentionally controlled to be raised.

The noise canceller disclosed by Tokuda may be convenient where several microphones may be selectively used. However, when a single microphone has to be moved to various sites, the noise canceller is little effective. The performance of noise suppression by means of the frequency subtraction highly depends upon the accuracy of the voice detection performed in advance on noisy sound. Otherwise, the performance will remarkably be degraded.

### SUMMARY OF THE INVENTION

It is therefore an object of the present invention to provide a sound signal adjuster for use in telephone circuitry with its circuit configuration simplified, and a method of implementing such a sound signal adjustment.

Basically, the present invention utilizes the natural behavior which the user takes when wishing to listen to a distal end talker on the phone to control the sound volume of a sound signal transmitted from the distal end talker.

More specifically, the present invention utilizes the general nature of a listener tending to more closely get his or her ear to a loudspeaker provided on a mobile phone handset in order to more clearly listen to a sound transmitted from a distal end talker.

In accordance with the present invention, a sound signal adjuster for use in telephone circuitry comprising a microphone for capturing sound to produce a first sound signal and a loudspeaker for reproducing sound represented by a distal end signal transmitted from a distal end to the telephone circuitry comprises a first circuit for obtaining a second sound signal representative of a sound in a vicinity of the loudspeaker; a second circuit operative in response to the first sound signal and the second sound signal for determining whether or not the sound in the vicinity of the loudspeaker is at least partially blocked; a first frequency characteristic extractor for extracting a frequency characteristic of the second sound signal, said first frequency characteristic extractor extracting a first frequency characteristic in response to said second circuit determining that the sound captured by the loudspeaker is at least partially blocked and a second frequency characteristic in response to said second circuit determining that the sound captured by the loudspeaker is substantially not blocked; a difference calculator for calculating a difference in frequency characteristic between the first and second frequency characteristics; and a third circuit for suppressing a noise component included in the first sound signal by means of the difference in frequency characteristic to transmit a first resultant signal to the distal end.

In accordance with the present invention, a computer program for adjusting a sound signal in telephone circuitry which comprises a computer, a microphone for capturing sound to produce a first sound signal and a loudspeaker for reproducing sound represented by a distal end signal transmitted from a distal end to the telephone circuitry functions, when installed in and executed on the computer, as the sound signal adjuster stated above.

Further in accordance with the present invention, a method of adjusting a sound signal in telephone circuitry comprising a microphone for capturing sound to produce a first sound signal and a loudspeaker for reproducing sound represented by a distal end signal transmitted from a distal end to the telephone circuitry comprises the steps of controlling: a first circuit to obtain a second sound signal representative of a sound in a vicinity of the loudspeaker; a second circuit to be operative in response to the first sound signal and the second sound signal to determine whether or not the sound in the vicinity of the loudspeaker is at least partially blocked; a first frequency characteristic extractor to extract a frequency characteristic of the second sound signal so that the first frequency characteristic extractor extracts a first frequency characteristic in response to the second circuit determining that the sound captured by the loudspeaker is at least partially blocked and a second frequency characteristic in response to the second circuit determining that the sound captured by the loudspeaker is substantially not blocked; a difference calculator to calculate a difference in frequency characteristic between the first and second frequency characteristics; and a third circuit to suppress a noise component included in the first sound signal by means of the difference in frequency characteristic to transmit a first resultant signal to the distal end.

In accordance with the present invention, the behavior of the user naturally taken when wishing to listen to a distal end talker on the phone is sensed in order to control the sound volume of a sound signal transmitted from a distal end talker. The user may thus use a telephone terminal equipped with the telephone circuitry in accordance with the invention to listen to the distal end user in an appropriate sound volume without speaking loudly on the phone or troublesomely or irritatively manipulating a key or button during the conversation otherwise interrupted and without being annoyed by the environmental conditions around the listener.

The inventive concept disclosed in the application may also be defined in ways other than in the claims presented below. The inventive concept may consist of several separate inventions particularly if the invention is considered in light of explicit or implicit subtasks or from the point of view of advantages achieved. In such a case, some of the attributes included in the claims may be superfluous from the point of view of separate inventive concepts. Within the framework of the basic inventive concept, features of different embodiments are applicable in connection with other embodiments.

In the context, the term “signal” may sometimes refer to noise in its broader sense. Otherwise, the signal may be understood as distinguishable from noise.

In the resent patent application, the sword “user” is directed to a person who deals with a telephone terminal unit, such as a mobile phone handset, including telephone circuitry in accordance with the present invention. The term “proximal end” refers to the location where the user stays, and the term “distal end” to a remote location where a party, or person, stays whom the user is connected to on the phone. In a broader sense, however, a party at the distal end may sometimes be referred also to a user. Such a user may sometimes be referred to as a “talker” when talking on the phone and also to a “listener” when listening to the other user.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of telephone circuitry in accordance with the present invention;

FIGS. 2A and 2B plot the signal levels developed from the transmitter and receiver level calculators included in the sound signal adjuster shown in FIG. 1;

FIG. 2C shows how the level corrector shown in FIG. 1 corrects the signal level output from the transmitter level calculator shown in FIG. 1;

FIG. 3 illustrates how the background noise is blocked when the loudspeaker is covered with an ear of the user in the embodiment shown in FIG. 1;

FIG. 4A illustrates how the level of noise captured by the loudspeaker and corrected by the level corrector changes when the noise blocking effect occurs on the loudspeaker shown in FIG. 1;

FIG. 4B illustrates how the level of noise captured by the microphone changes when the noise blocking effect takes place on the loudspeaker shown in FIG. 1;

FIG. 5 shows part of an alternative embodiment of the telephone circuitry in accordance with the present invention in a schematic block diagram;

FIG. 6 shows, like FIG. 5, part of another alternative embodiment of the telephone circuitry in accordance with the invention in a schematic block diagram;

FIG. 7 shows part of a further alternative embodiment of the telephone circuitry in accordance with the invention in a schematic block diagram;

FIGS. 8A and 8B plot the signal characteristics developed from the transmitter and receiver characteristic calculators included in the sound signal adjuster shown in FIG. 7;

FIG. 8C shows how the characteristic corrector shown in FIG. 7 corrects the signal characteristic signal output from the transmitter characteristic calculator shown in FIG. 7;

FIG. 9A shows how the noise blocking effect causes the frequency characteristic of the receiver noise signal to drop;

FIG. 9B plots the drop of the frequency characteristic difference shown in FIG. 9A with respect to the frequency;

FIG. 10 shows part of a still further alternative embodiment of the telephone circuitry in accordance with the invention in a schematic block diagram; and

FIG. 11 shows still another alternative embodiment of the telephone circuitry in accordance with the invention in a schematic block diagram.

### DESCRIPTION OF THE PREFERRED EMBODIMENTS

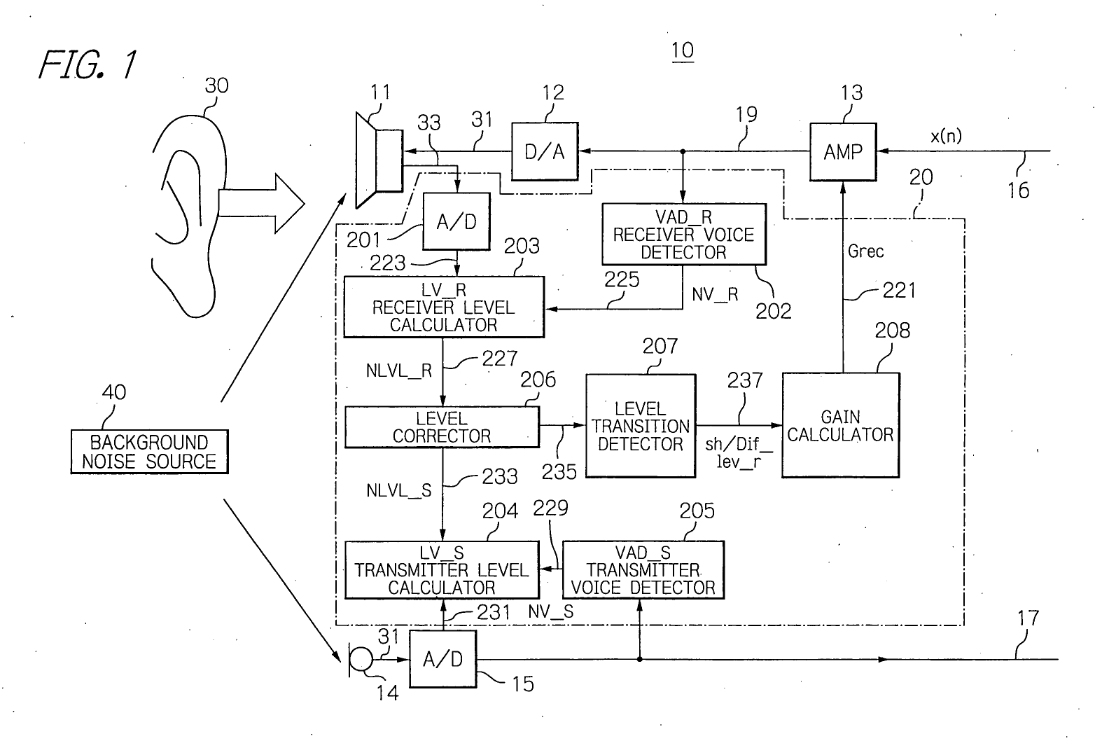

With reference first to FIG. 1, telephone circuitry 10 in accordance with a preferred embodiment of the present invention includes a loudspeaker 11 and a microphone 14 as well as a sound signal adjuster 20 adapted to determine when sound incoming to the loudspeaker 11 is blocked to a certain extent to in turn correspondingly amplify a talk signal transmitted from a distal end to the circuitry 10 so as to enable the proximal end listener to more clearly listen to the sound conveyed on the talk signal.

The telephone circuitry 10 may advantageously be, or be installed in, a mobile phone terminal unit or a handset for use in a land-line telephone subscriber set or terminal, which both may anyway be referred to as a telephone “handset”. In practice, the telephone circuitry, or handset, 10 may usually include circuits and functions, such as a line circuit and a dial key pad, necessary for originating and terminating a call and for transmitting and receiving control and talk signals to and from a base or central station of a telephone network system, although not specifically shown in the figure. Such circuits and functions will not specifically be described or shown so far as they are not necessary for understanding the invention.

FIG. 1 shows on its left hand side the proximal end to the user, who may be the listener or talker when appropriate and is symbolically shown with his or her ear 30, while showing on its right hand side the direction of the distal end to the base or central station which is adapted to switch calls to and from a distal end terminal device, also not shown. In the context, the user may be designated by the reference numeral 30 although his or her ear or even auricle may sometimes be designated by “30”. Generally, the telephone circuitry 10 has a pair of lines 16 and 17 which are interconnected to the receiver and transmitter circuits, respectively, of the mobile phone terminal, or the subscriber line circuit of the land-line telephone subscriber set, not shown either, as the case may be.

In general, the telephone circuitry 10 is adapted to get a background, or surrounding, sound noise caught by a loudspeaker 11 in the form of noise signal 33 to determine the level of the noise signal 33, which is compared with another noise signal component 231 obtained by a microphone 14 in order to determine how the noise signal 33 drops to a predetermined extent to estimate the noise blocking effect caused by the auricle of the user, and then a gain calculator 208 selects an enhanced gain value with which a variable-gain amplifier 13 amplifies a distal end signal 16. This utilizes the general nature of the listener 30 tending to more closely get his or her ear to the loudspeaker 11 in order to more clearly listen to the sound conveyed by the distal end signal 16.

The microphone 14 is arranged to capture a sound, particularly voice uttered by the user, i.e. talker, and transduce the sound to a corresponding electric signal 31 to output the latter to an analog-to-digital (A/D) converter 15. The A/D converter 15 is adapted to convert the electric signal, or analog voice signal, 31 to a corresponding digital signal 17 to output the latter, which is in turn transmitted to the distal end. The digital proximal end signal 17 is also connected to a transmitter voice detector (VAD_S) 205 included in the voice signal adjuster 20. Signals are thus designated with reference numerals of connections on which they are conveyed.

From the distal end, a digital signal mainly representing a voice signal component transmitted from the distal end is received on the connection 16 by a variable-gain amplifier (AMP) 13. In the illustrative embodiment, the distal end signal is in the form sampled at discrete time intervals and having its value represented by x(n), where n is the ordering number of a sampling point. The variable-gain amplifier 13 has its control port 221 interconnected to a gain calculator 208 included in the voice signal adjuster 20. The amplifier 13 has its amplifier gain variable in response to a gain control signal 221, described later, and is adapted to amplify the distal end signal 16 with its gain to output a resultant signal 19 to a digital-to-analog (D/A) converter 12 and a receiver voice detector (VAD_R) 202 also comprised of the voice signal adjuster 20.

Specifically with the illustrative embodiment, the variable gain amplifier 13 has its gain settable to two values, a default value and an amplifying value. The default gain may preferably be equal to unity, i.e. 1.0, and the amplifying gain to 12 dB with the embodiment but they are not limitative. The variable gain is initialized to its default value. The amplifier 13 may be adapted to have three or more gain values, or has its gain steplessly variable.

The D/A converter 12 is adapted to convert the digital signal 19 to a corresponding analog signal 31, which will drive the loudspeaker 11. The loudspeaker 11 is arranged to transduce the analog signal 31 to a corresponding audible sound to reproduce the latter, which the user, or listener, 30 will listen to. The loudspeaker may sometimes be referred to as an earphone in the context. The loudspeaker 11 may be of any types of electro-acoustic transducer known per se, such as a diaphragm type of loudspeaker. Such a loudspeaker may, in general, have its property in nature of transduction in a bi-directional way, so that the loudspeaker 11 may have its diaphragm or vibrator plate forced to vibrate with the environmental sound therearound, such as background sound noise, to transduce the noise to a corresponding electric signal 33, or noise signal, which will be input to another A/D converter 201 included in the sound signal adjuster 20.

The other A/D converter 201 is adapted for converting the electric signal, or analog noise signal, 33 to a corresponding digital signal 223 to output the latter, which is in turn transferred to a receiver level calculator (LV_R) 203. The receiver level calculator 203 has its control port 225 interconnected to the output from the receiver voice detector 202, and is adapted to be operative in response to the enable signal 225 to determine, or extract, the level of the signal 223, which represents the environmental sound captured as a background sound noise by the loudspeaker 11. With an alternative embodiment, another microphone, not shown, may be provided in the vicinity of the loudspeaker 11 dedicatedly for capturing the environmental sound. The receiver level calculator 203 has its output 227 interconnected to one input of a level corrector 206.

The receiver voice detector 202 is adapted to receive the amplified distal end signal 19 to determine when the distal end signal 19 conveys a voice signal component transmitted by the talker on the distal end terminal, not shown, and to render the control signal 225 enable when it fails to detect a voice signal component in the distal end signal 19 whereas rendering the control signal 225 disable when it detects a voice signal component in the distal end signal 19. The receiver voice detector 202 may utilize the function included in the existing telephone terminal unit on which the telephone circuitry 10 is installed. Further details of the receiver voice detector 202 will be described later on.

The transmitter voice detector 205 is adapted to receive the digital proximal end signal 17 to determine when the proximal end signal 17 conveys a signal component of the voice uttered by the talker 30 on the proximal end terminal, and to render the control signal 229 enable when it detects no voice signal component in the proximal end signal 17 whereas rendering the control signal 229 disable when it detects a voice signal component in the proximal end signal 17. Anyway, further details of the receiver voice detector 205 will also be described later.

The control signal 229 from the transmitter voice detector 205 is connected to one input of a transmitter level calculator (LV_S) 204. The transmitter level calculator 204 has its other input port 231 interconnected to another output 231 of the earlier-mentioned A/D converter 15. The transmitter level calculator 204 is adapted to be operative in response to the enable signal 229 to determine, or extract, the level of the signal 231, which includes a signal component of sound, i.e. background noise in that case, captured by the microphone 14. The transmitter level calculator 204 has its output 233 interconnected to the other input of the level corrector 206.

The level corrector 206 serves as compensating for a difference in level between the sound signals captured by the loudspeaker 11 and microphone 14. Such a difference is caused by the loudspeaker 11 being in its nature inferior to the microphone 14 in the property of capturing sound. Specifically, the level corrector 206 is adapted to compare the couple of inputs 227 and 233 with each other, which represent the level calculated by the receiver and transmitter level calculators 203 and 204, respectively, to determine a difference in level between the couple of sound signals, and to thereafter compensate for the difference on the signal received on its input port 227 from the receiver level calculator 203. The level corrector 206 outputs the signals 227 and 233 thus corrected to an input 235 of a level transition detector 207. Further details of the level corrector 206 will also be described later on.

The level transition detector 207 functions as detecting a change, or transition, of level involved in the signals appearing on its input port 235. More specifically, the level transition detector 207 is adapted to detect an abrupt drop in level of the input signal 235 coming from the receiver level calculator 203 to in turn produce a level drop detection signal 237 to the gain calculator 208. Further details of the level transition detector 207 will also be described later on.

The gain calculator 208 is adapted to be responsive to the level drop detection signal 237, when enabled, to calculate a gain with which the variable-gain amplifier 23 amplifies the input distal end signal 16. The gain thus calculated will be delivered in the form of control signal 221 to the variable-gain amplifier 13. Specifically, with the illustrative embodiment, the amplifier 13 is adapted to have two selectable gains as described above. The gain calculator 208 is thus adapted to be responsive to the enable signal sh, when enabled, on its input port 237 to output an enable signal Grec on its output port 221 so as to render the amplifier select the amplifying gain value, 12 dB in the embodiment.

Now, the receiver voice detector 202 will be described more in detail. The receiver voice detector 202 is adapted to determine whether or not the input distal end signal 19 includes a voice signal component transmitted by a talker on the distal end terminal. The receiver voice detector 202 determines the presence or absence of a voice signal component by utilizing the nature of a possible separation between a long-term and a short-term smoothness in level of the distal end signal 19.

For example, a long-term smoothness ABS_L(n) and a short-term smoothness ABS_S(n) in level of the input distal end signal x(n) are respectively defined by, for example,

ABS_{—}L(n)=(1.0−δ1)ABS_{—}L(n−1)+δ1|x(n)| (1)

ABS_{—}S(n)=(1.0−δ2)ABS_{—}S(n−1)+δ2|x(n)|, (2)

where a pair of vertical bars in the term “|x(n)|” represents the absolute value of the signal x(n). Instead of an absolute value, a square value may be employed. The receiver voice detector 202 may be adapted to utilize the long- and short-term smoothness characteristics in order to determine whether or not a voice signal component is involved in the distal end signal 19.

The notations δ1 and δ2 represent coefficients which satisfy the relations δ1<δ2, and 0<δ1<1.0 and 0<δ2<1.0. In the illustrative embodiment, coefficients δ1=0.0001 and δ2=0.01. Those exemplified values are not limitative but any other values are applicable. If the coefficients take larger values, then the receiver voice detector 202 is apt to follow a more abrupt change in smoothness but to be more sensitive to noise, and vice versa, namely if the coefficient values become smaller, then the voice detector 202 is apt to follow a more general change in smoothness but to be less sensitive to noise.

The receiver voice detector 202 may be adapted to compare both smoothness characteristics ABS_L(n) and ABS_S(n) with each other by means of a threshold value TH_VAD. For example, if the following relation is maintained,

ABS_{—}S(n)≧ABS_{—}L(n)+TH_{—}VAD (3)

then the receiver voice detector 202 determines that a voice signal component exists in the distal end signal x(n) to issue an enable signal NV_R on its output port 225. The value of the threshold may be equal to 6 dB, in the illustrative embodiment, but may not be restrictive.

The transmitter voice detector 205 may be adapted similarly to the receiver voice detector 202 except that the former detects a voice signal component involved in the proximal end signal 17 coming from the microphone 14 to output an enable signal NV_S on its output port 229. Repetitive description is avoided.

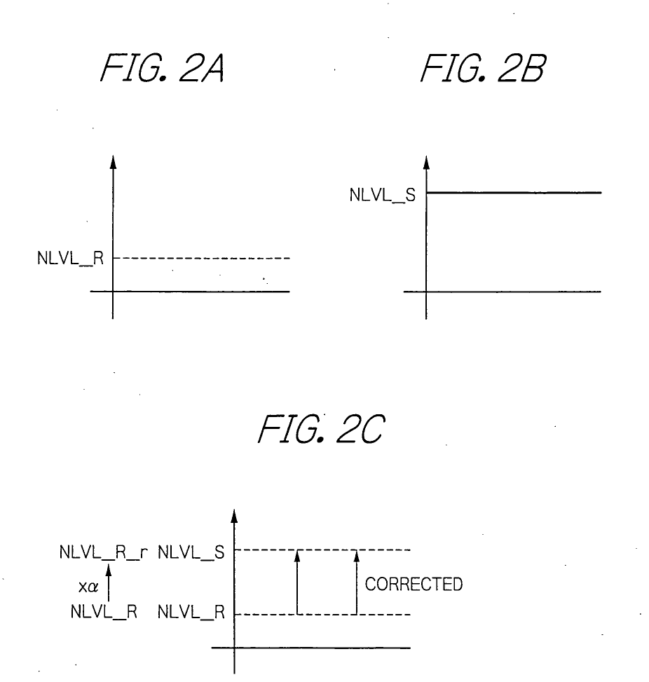

With reference to FIGS. 2A, 2B and 2C, the level corrector 206 will be described in more detail. As described earlier, the receiver level calculator 203 is operative in response to the enable signal 225, when enabled, to determine the level of the signal 223 to produce an output signal NLVL_R to the one input 227 of the level corrector 206. Similarly, the transmitter level calculator 204 is responsive to the enable signal 229, when enabled, to determine the level of the signal 231 to output the output signal NLVL_S to the other input 233 of the level corrector 206. In general, the signals NLVL_R and NLVL_S take the levels plotted in FIGS. 2A and 2B, respectively. More specifically, the signal NLVL_R is generally lower in level than the signal NLVL_S because of the fact that so far as the ability of capturing sound is concerned the loudspeaker 11 is in its nature inferior to the microphone 14.

The level corrector 206 first compares both signals NLVL_R and NLVL_S with each other to determine a difference therebetween, and then, as depicted in FIG. 2C, corrects the lower signal NLVL_R to a new level NLVL_R_r by multiplying the signal NLVL_R with a correction coefficient α so as to be substantially equal to the higher signal NLVL_S. The correction coefficient α may thus be dependent upon the difference thus determined. The coefficient α is now held in the level corrector 206 for future use.

Alternatively, the level corrector 206 may be designed so that the value of the correction coefficient α is selected in advance by taking account of the difference in property of capturing sound of the loudspeaker 11 from the microphone 14.

In operation, the level corrector 206 then multiplies the signal NLVL_R received from the A/D converter 15 with that correction coefficient α to thereby obtain the corrected signal NLVL_R_r to output the latter on its output port 235 to the level transition detector 207.

The level corrector 206 may be removed in an application where the signal output from the A/D converter 31 has its dynamic range broader sufficiently for transferring the receiver level signal NLVL_R as the corrected receiver level signal NLVL_R_r. In that case, the outputs 227 and 233 of the receiver and transmitter level calculators 203 and 204, respectively, may be interconnected directly to the input 235 of the level transition detector 207, thus giving rise to simplifying the configuration of, and saving the power consumed by, the telephone circuitry 10.

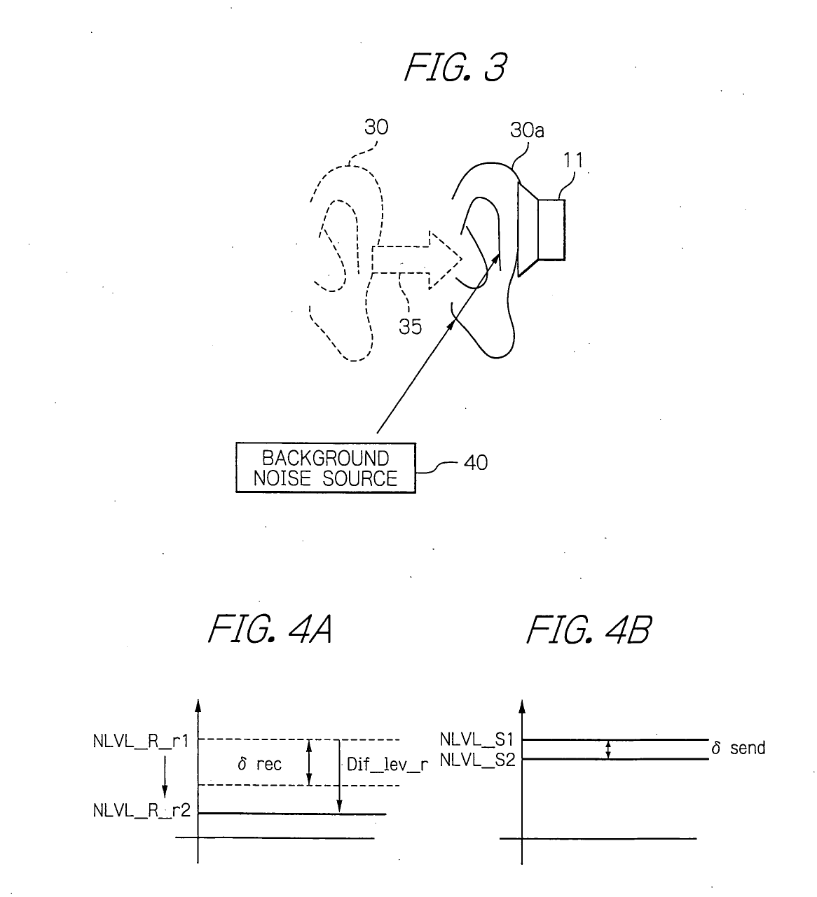

The level transition detector 207 is provided for the purpose of determining when the loudspeaker 11 is substantially covered with an ear 30 of the listener, i.e. proximal end talker. With reference to FIG. 3, the listener generally tends to get his or her ear closer to the loudspeaker 11 when he or she is hard to listen to the voice transmitted from the distal end terminal, thus rendering the loudspeaker 11 covered with the auricle of the ear 30 to the extent that the noise generated by a background, or environmental, noise source, conceptually depicted with a rectangular block 40 in FIG. 3, is substantially prevented from entering the loudspeaker 11. The auricle 30 may thus function as a sound barrier to the noise for the loudspeaker 11.

In general, telephone handsets, particularly mobile phone terminals, are designed to be more and more miniaturized to the extent that part of the housing or frame of handsets which encloses a loudspeaker or earphone is not so designed in shape with importance placed as to suitably fit the shape of the human ear. This means that it is difficult to establish, as disclosed in Suzuki stated earlier, a tight space by the tympanic membrane and external auditory canal of the human ear and the outer contour of the surface of the part of the handset housing having the loudspeaker mounted. However, the auricle brought closer to the loudspeaker at least effects a sound barrier for partially preventing the noise from entering the loudspeaker although failing to tightly fit the contour of the handset housing.

FIG. 3 depicts, with an arrow 35, how the ear 30 is brought closer to a position 30a so as to cover the loudspeaker 11 to block the background noise emitted by the noise source 40. Then, the noise level NLVL_R developed by the receiver level calculator 203, and hence the corrected level NLVL_R_r, is lowered correspondingly to the sound barrier thus formed.

Reference will be made to FIGS. 4A and 4B to describe how to detect the loudspeaker 11 being blocked against the background, or surrounding, noise. That may sometimes be referred to as noise blocking effect. For example, at a certain instant, the noise level NLVL_R_r to which the input signal 33 captured by the loudspeaker 11 is corrected by the level corrector 206 takes the value NLVL_R_r1 shown in FIG. 4A, and the noise level NLVL_S captured by the microphone 14 takes the value NLVL_S1 shown in FIG. 4B. At another instant following thereto, it is assumed that the noise level NLVL_R_r takes the value NLVL_R_r2, FIG. 4A, and the noise level NLVL_S takes the value NLVL_S1, FIG. 4B. Thus, FIG. 4A implies that the noise level NLVL_R_r captured by the loudspeaker 11 and corrected by the level corrector 206 drops from NLVL_R_r1 to NLVL_R_r2 due to the noise blocking effect occurring on the loudspeaker 11, whereas FIG. 4B shows no substantial drop in level NLVL_S between the transmitter signal levels NLVL_S1 and NLVL_S2. Such a difference in level drop between FIGS. 4A and 4B relies upon the fact that the design of handset housings usually hardly allows part of the user's face to substantially cover but merely approach the microphone 14.

Taking that fact into account, the level transition detector 207 is designed to determine that the noise blocking effect occurs when a drop in level from NLVL_R_r1 to NLVL_R_r2 exceeds a predetermined value δrec, FIG. 4A, namely such a drop satisfies the expression,

NLVL_{—}R_{—}r2<NLVL_{—}Rr1−δrec. (4)

In the context, such a drop of the level determined by means of the expression may be referred to as an abrupt drop. In the illustrative embodiment, the threshold δrec may be set to a value of 6 dB.

Such an abrupt drop of level NLVL_R_r may be detected by determining, for example, when the level NLVL_R_r takes the maximum value as NLVL_R_r1 and when the minimum value as NLVL_R_r2 since the telephone circuit 10 is in operation, and then if both values NLVL_R_r1 and NLVL_R_r2 satisfy the expression (4), then the timing at which the value NLVL_R_r2 was taken is defined as the timing at which the abrupt drop occurred. Alternatively, an abrupt drop of level NLVL_R_r may be detected by, for example, sampling the level NLVL_R_r at a predetermined interval to take a level NLVL_R_r1 sampled at an immediately preceding sampling time point and a level NLVL_R_r2 at a current sampling time point, and then if both values NLVL_R_r1 and NLVL_R_r2 satisfy the expression (4), then the timing at which the value NLVL_R_r2 was sampled is defined as the timing at which the abrupt drop took place. Thus, the way of determining the timing at which an abrupt drop of the level may not be restrictive to the specific examples.

In respect of the transmitter level NLVL_S, as shown in FIG. 4B, it may be determined by means of the following expression whether or not a level transition is caused by the background noise,

NLVL_{—}S2<NLVL_{—}S1−δsend, (5)

where δsend represents a threshold for determining a level transition caused by noise and may be set to 3 dB with the embodiment, for example.

When the noise blocking effect occurs on the transmitter side, i.e. on the microphone 14, it is presumed, for instance, that the handset may be put on a desktop with its microphone side down or that the microphone may be covered with the hand of the talker, or otherwise that the talker may not converse while the background noise source 40 per se may steeply have decreased. Therefore, when the relation (5) is maintained, the level transition detector 207 would, even if the relation (4) is satisfied, not develop the enable signal sh on its output 237. This means that the variable-gain amplifier 13 has its gain set to the default value, e.g. unity, as described later. When the relation (4) is satisfied without maintaining the relation (5), the level transition detector 207 sets its output 237 enabled, i.e. issues the enable signal sh to the gain calculator 208. Otherwise, the level transition detector 207 does not issue the enable signal sh.

The illustrative embodiment of the telephone circuitry 10 is depicted and described as configured by separate functional blocks, such as the transmitter voice detector 205. It is however to be noted that such a depiction and a description do not restrict the telephone circuitry 10 to an implementation only in the form of hardware but at least the sound signal adjuster 20 may partially or entirely be implemented by software, namely, by a computer, or processor system, which has a computer program installed and functions, when executing the computer program, as part of, or the entirety of, the sound signal adjuster 20. That may also be the case with illustrative embodiments which will be described below. In this connection, the word “circuit” or “circuitry” may be understood not only as hardware, such as an electronics circuit, but also as a function that may be implemented by software installed and executed on a computer.

In operation, the distal end signal transmitted from a distal end talker over the receiver line 16 is input through the amplifier 13 to the D/A converter 12, which in turn converts the input digital signal 19 to a corresponding analog signal 31 to drive the loudspeaker 11. The loudspeaker 11, on the one hand, transduces the analog signal 31 to sound, to which the listener 30 listens.

On the other hand, the loudspeaker 11 may catch the background sound noise emitted from the background noise source 40 to transduce it to an electric signal 33, which is in turn input to the A/D converter 201 to be converted to a corresponding digital signal 223, actually noise, which will be input to the receiver level calculator 203.

The microphone 14 may capture the voice, when uttered by the user 30, and also a possible background noise generated by the background noise source 40. The voice and possible noise are transduced by the microphone 14 to an electric signal 31, which is converted by the A/D converter 15 to the corresponding digital signals 17 and 231. The former signal 17 will be transmitted toward the distal end listener over the telephone network, not shown, as well as input to the transmitter voice detector 205. The latter signal 231 will be input to the transmitter level calculator 204.

The receiver voice detector 202 monitors the distal end signal 19. When the receiver voice detector 202 determines that the distal end signal 19 does not carry a voice signal component, the detector 202 develops on its output 225 an enable signal NV_R indicative of the absence of voice signal component to the control input of the receiver level calculator 203. The enable signal 225 primes the receiver level calculator 203, which in turn calculates the level of the signal 223 coming from the loudspeaker 11 via the A/D converter 201. The resultant signal 227 indicative of the level NLVL_R thus calculated will be forwarded to the one input of the level corrector 206.

The transmitter voice detector 205 monitors the proximal end signal 17. When the detector 205 detects no voice signal component in the proximal end signal 17, the detector 205 enables its output 229 to output the enable signal NV_S representing the absence of voice signal component to the control input of the transmitter level calculator 204. The transmitter level calculator 204 is primed with the enable signal 229 to calculate the level of the proximal end signal 31, now only including noise, from the digital signal 231 to produce a signal NLVL_S representing the level thus calculated to the other input 233 of the level corrector 206.

Thus, the level corrector 206 receives the receiver level signal NLVL_R and the transmitter level signal NLVL_S on its input ports 227 and 233, respectively, and then corrects the receiver level signal NLVL_R to the corrected level NLVL_R_r by multiplying the former signal with the correction coefficient α in the manner described earlier with reference to FIG. 2C. The resultant signal representative of the corrected level NLVL_R_r will be supplied to the level transition detector 207 together with the signal representative of the transmitter level NLVL_S over the connection 235.

The level transition detector 207 then determines which of the relations (4) and (5) is satisfied. If the relation (4) is satisfied without maintaining the relation (5), then the detector 207 determines that the loudspeaker 11 is blocked from the noise to the predetermined extent and issues on its output 237 the enable signal sh to the gain calculator 208. In turn, the gain calculator 208 selects the gain value higher than the default value, which is to be set while it is not supplied with the enable signal sh. The gain calculator 208 then outputs on its output port 221 the signal Grec representing the selection of the increased gain. In response, the variable-gain amplifier 13 amplifies the distal end signal x(n) received on its input port 16 with the increased gain.

Otherwise, namely, if the relation (5) is satisfied, or the relations (4) and (5) are not satisfied, then the level transition detector 207 sets its output 237 disabled, i.e. issues no enable signal sh to the gain calculator 208. In turn, the gain calculator 208 sets the variable-gain amplifier 13 so as to amplify the distal end signal x(n) with its default gain, i.e. not to amplify the distal end signal, in the embodiment.

In summary, the telephone circuitry 10 in accordance with the illustrative embodiment is adapted to get a background sound noise caught by the loudspeaker 11 in the form of noise signal 33 to determine the level of the noise signal 33, which is compared with the noise signal component 231 obtained by the microphone 14 to determine how the noise signal 33 drops to the predetermined extent to presume the noise blocking effect caused by the auricle 30 of the user, and then the gain calculator 208 selects the enhanced gain value with which the variable-gain amplifier 13 amplifies the distal end signal 16. This utilizes the general nature of the listener 30 tending to more closely get his or her ear to the loudspeaker 11 in order to more clearly listen to the sound conveyed by the distal end signal 16. The telephone circuitry 10 is thus of a simpler structure without adding a discrete component such as an acoustic pressure sensor as conventionally required. The user may use a telephone terminal equipped with the telephone circuitry 10 to listen to the distal end user with appropriate sound volume without speaking loudly on the phone or manipulating a key or button during the conversation otherwise interrupted.

The illustrative embodiment includes the receiver level calculator 203 adapted to determine the level of the signal 223 to produce the output signal NLVL_R, and the transmitter level calculator 204 is adapted to determine the level of the signal 231 to produce the output signal NLVL_S. Alternatively, the receiver long- or short-term smoothness characteristic ABS_L(n) or ABS_S(n) derived by the receiver voice detector 202 may be used as the level signal NLVL_R, rather than the receiver level calculator 203 calculating the receiver signal level NLVL_R. Correspondingly, the transmitter long- or short-term smoothness characteristic ABS_L(n) or ABS_S(n) derived by the transmitter voice detector 205 may be used as the level signal NLVL_S, rather than the transmitter level calculator 205 calculating the transmitter signal level NLVL_S.

In the illustrative embodiment shown in and described with reference to FIG. 1, the variable-gain amplifier 13 has its gain switchable to two steps, i.e. the default and enhanced gain values. As an alternative embodiment, the variable-gain amplifier 13 may be adapted to switch its gain steplessly under the control of the gain calculator 208. With that alternative embodiment, the level transition detector 207 may be adapted to calculate a difference, or drop, Dif_lev_r of the receiver signal level NLVL_R_r, i.e. from a previous value NLVL_R_r1 to a current value NLVL_R_r2, FIG. 4A.

More specifically, with the instant alternative embodiment, the level transition detector 207 is adapted to compare, when the relation (4) described above is satisfied without maintaining the relation (5), the current value NLVL_R_r2 with the previous value NLVL_R_r1 to calculate a difference of the former from the latter, namely by means of the following expression,

Dif_{—}lev_{—}r=NLVL_{—}R_{—}r2−NLVL_{—}R_{—}r1 (6)

to output the resultant signal 237 representative of the value of difference, Dif_lev_r, thus obtained. Otherwise, that is, if the relation (5) is satisfied, or the relations (4) and (5) are not satisfied, then the level transition detector 207 sets its output 237 to the value of 0 dB.

The timing at which the difference Dif_lev_r is detected may be the same as described earlier with reference to expression (4). Actually, the difference Dif_lev_r may be taken into account only when the difference reveals a drop, more particularly an abrupt drop, of the current background noise lever NLVL_R_r2 from the previous one NLVL_R_r1.

With the instant alternative embodiment, the gain calculator 208 may be adapted, for example, to multiply the difference signal Dif_lev_r input from the level transition detector 207 with a coefficient δ20 to output the resultant signal Grec on its output port 221. The signal Grec is thus represented as

Grec=δ20*Dif_{—}lev_{—}r, (7)

where the asterisk denotes “multiplied by”. The coefficient δ20 is a constant for amplifying the difference, and may be equal to 2.0 with the alternative embodiment but not restrictive.

The gain calculator 208 develops on its output 221 a gain control signal representative of the value Grec thus calculated. The variable-gain amplifier 13 is responsive to the gain control signal 221 to amplify the input distal end signal accordingly to the gain Grec thus input.

The gain calculator 208 may not necessarily use the expression (7) but may be adapted otherwise so far as it can obtain for the amplifier 13 a gain value which is substantially proportional to or associated with the difference Dif_lev_r of a current value NLVL_R_r2 from a previous value NLVL_R_r1.

The gain calculator 208 may be adapted, rather than to calculate the gain Grec on a real-time basis as described above, to obtain the gain value Grec associated with a difference by referencing data in a storage, such as a lookup table, which stores therein appropriate gain values that are associated with values of the difference and established in experience or experiment in advance.

In operation, when the relation (4) is satisfied but not the relation (5), the level transition detector 207 determines the loudspeaker 11 being blocked from the noise to the predetermined extent, and thus compares the current value NLVL_R_r2 with the previous value NLVL_R_r1 to get a difference therebetween from the expression (6) to output the resultant value of difference Dif_lev_r on its output 237. Otherwise, the level transition detector 207 outputs the signal Dif_lev_r indicative of the value of 0 dB on its output 237.

The gain calculator 208 receives the difference signal Dif_lev_r from the level transition detector 207, and in turn multiplies the difference with the coefficient δ20 to output the resultant signal Grec on its output port 221 to the variable-gain amplifier 13. The variable-gain amplifier 13 responds to the gain control signal 221 to amplify the input distal end signal accordingly to output the thus amplified signal to the D/A converter 12 and receiver voice detector 202.

In short, the telephone circuitry 10 in accordance with the alternative embodiment is adapted to get by the level transition detector 207 an abrupt drop in level of a background noise caught by the loudspeaker 11 to calculate the amount of the drop, according to which the gain calculator 208 calculates an increased gain value, with which the variable-gain amplifier 13 amplifies the distal end signal 16. The user 30 may listen to the distal end user with an appropriate sound volume more smoothly, or steplessly, increased.

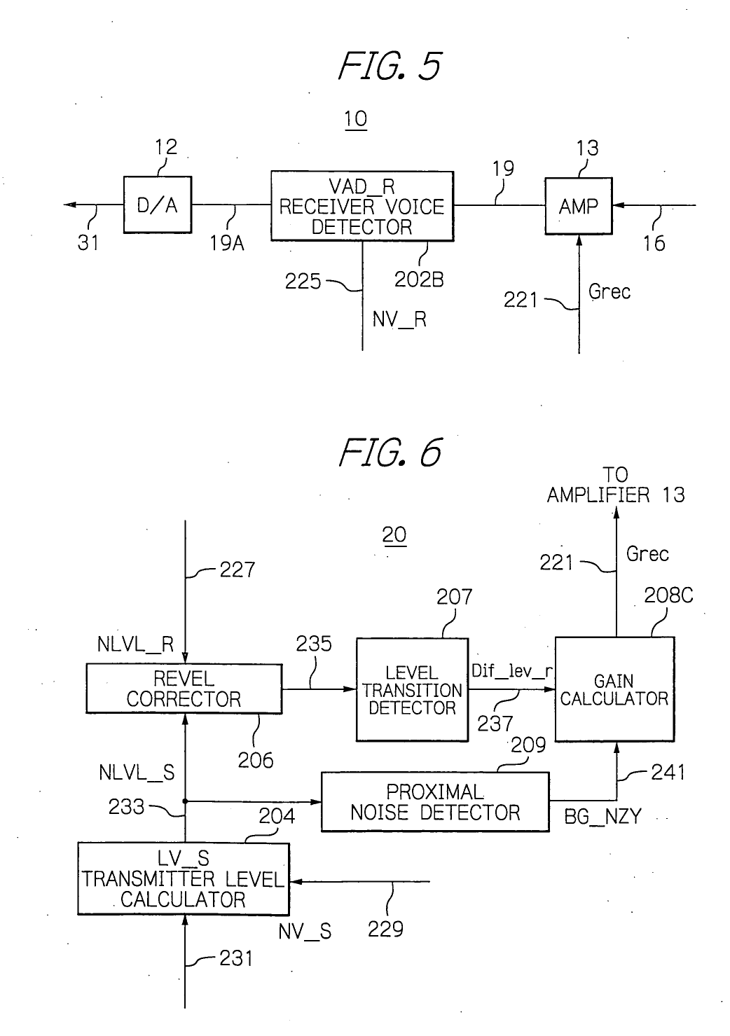

In another alternative embodiment, the receiver voice detector 202 may be arranged on the connection 19 between the variable-gain amplifier 13 and the D/A converter 12 as a receiver voice detector 202B shown in FIG. 5. In the present patent application, like components are designated with the same reference numerals, and repetitive description on such components will be avoided for simplicity.

The receiver voice detector 202B has its input port interconnected to the output port 19 of the variable-gain amplifier 13 and its one output port 19A interconnected to the input port of the D/A converter 12. The receiver voice detector 202B has its other output port interconnected to the control input port 225 of the receiver level calculator 203, FIG. 1.

The receiver voice detector 202B is adapted to determine whether or not the distal end signal 19 conveys a voice signal component coming from the distal end talker. The receiver voice detector 202B receives the distal end signal 19, and transfers, if it determines that the signal 19 includes a voice signal component, the signal 19 to the D/A converter 12 on its one output 19A. If the receiver voice detector 202B fails to detect a voice signal component in the distal end signal 19, then it blocks the signal 19 from being transferred to the D/A converter 12 and enables the control signal NV_R on its output port 225. The remaining functions may be the same as the receiver voice detector 202 shown in FIG. 1.

In operation, the receiver voice detector 202B receives the distal end signal 19 coming from the distal end talker, and determines whether or not the distal end signal 19 includes a voice signal component. The receiver voice detector 202B usually, namely when the signal 19 includes a voice signal component, transfers the signal 19 to the D/A converter 12 on its one output 19A. If the receiver voice detector 202B detects no voice signal component in the distal end signal 19, then it ceases the signal 19 from being output to the D/A converter 12 and enables the control signal NV_R on its output port 225 to prime the receiver level calculator 203.

As described above, when no voice signal component is detected in the distal end signal 19, then the receiver voice detector 202B stops passing the signal 19 received from the variable-gain amplifier 13 to the D/A converter 12. Otherwise, namely, unless the receiver voiced detector 202B blocks the distal end signal 19 including no voice signal component, a relatively larger noise component, when included in the distal end signal 19, would be transduced by the loudspeaker 11 as a noise sound, which could be fed back as an echo possibly included in the background signal 223, caused by the background noise source 40, to the receiver level calculator via the A/D converter 201 so that the sound signal adjuster 20 could erroneously be operated. Specifically, the receiver level calculator 203 could incorrectly calculate the level of the background noise signal 33, which thus includes the larger noise coming from the distal end, thus degrading the accuracy of the sound signal adjuster 20 in calculating the proximal background noise caused by the noise source 40. However, the instant alternative embodiment, capable of blocking a distal end noise from driving the loudspeaker 11, is free from such an incorrect calculation of the proximal background noise.

With reference to FIG. 6, a further alternative embodiment additionally includes a proximal noise detector 209, which has its input port interconnected to the output port 233 of the transmitter level calculator 204 and is adapted for determining whether or not the proximal end signal 31 caught by the microphone 14 carries a noise signal component whose level exceeds a predetermined threshold. The proximal noise detector 209 has its output port 241 interconnected to a gain calculator 208C.

The telephone circuitry 10 in accordance with the present alternative embodiment includes the gain calculator 208C in place of the gain calculator 208 shown in and described with reference to FIG. 1. The gain calculator 208C may be the same as the gain calculator 208 except that the calculator 208C has the additional input port 241 interconnected to the output of the proximal noise detector 209 and is adapted to receive on its other input port 237 the difference signal Dif_lev_r, described above, from the level transition detector 207 and to calculate a gain value appropriate for the presence or absence of the proximal end noise when included in the proximal end signal 231.

More in detail, the proximal noise detector 209 is adapted to be responsive to the input transmitter noise signal 233 and compare the proximal noise level NLVL_S included in the proximal end signal 233 to a predetermined threshold TH_BG_S. If the proximal noise level NLVL_S exceeds the predetermined threshold TH_BG_S, then the proximal noise detector 209 determines that the proximal talker 30 is in the environment full of noise, thus issuing an enable signal BG_NZY on its output port 241. The comparison may be represented by, for example,

NLVL_S>TH_BG_S. (8)

Whenever the relation (8) is satisfied, the enable signal BG_NZY will be transferred to the gain calculator 208C. Otherwise, the output port 241 is disabled, namely no effective signal is developed on the output port 241. The variable-gain amplifier 13 amplifies the input distal end signal 16 with the gain Grec provided on its input port 221 from the gain calculator 208C. Rather than the enable signal BG_NZY thus representing the presence of a larger proximal end noise, the proximal noise detector 209 may be adapted for producing the enable signal BG_NZY which represents the amount, or level, of such a larger proximal end noise thus detected.

The threshold H_BG_S may be defined as an extensive background noise threshold, and may be set equal to −30 dBm0 off the digital amplitude value with the instant alternative embodiment, in which 0 dBm0 is defined on the basis of the amplitude of a tonal signal at 1 kHz provided under the International Telecommunication Union Telecommunication Standardization Sector (ITU-T), Recommendation G.711. Of course, the conditions set to the proximal noise detector 209 and gain calculator 208C are not to be restricted to those specific values.

The gain calculator 208C is adapted to receive the difference signal Dif_lev_r on its input 237 from the level transition detector 207 to calculate the gain Grec in response to the presence or absence of the enable signal BG_NZY on its additional input port 241 by means of the following expressions,

Grec=δ40*Dif_{—}lev_{—}r,if BG_{—}NZY exists (9)

Grec=δ41*Dif_{—}lev_{—}r,otherwise (10)

where δ40≧δ41, (11)

With the present alternative embodiment, the coefficients δ40 and δ41 are magnification constants for amplifying the difference, and may be equal to 4.0 and 2.0, respectively, but not restrictive.

The gain calculator 208C may not necessarily use the expressions (9) and (10) but may be adapted otherwise as far as it can obtain for the amplifier 13 a gain value which is associated with the difference Dif_lev_r of a current value NLVL_R_r2 from a previous value NLVL_R_r1, as described earlier and the relation (11) is maintained. The gain calculator 208C may be adapted, rather than to calculate a gain value Grec on a real-time basis as described above, to obtain a gain value by referencing data in a storage, such as a lookup table, which stores therein such appropriate gain values established in experience or experiment in advance as to increase when the enable signal BG_NZY is provided.

With the present alternative embodiment, the variable-gain amplifier 13 may be replaced with an analog type of variable-gain amplifier, not shown, disposed on the output port 31 of the D/A converter 12 prior to the loudspeaker 11, and the analog variable-gain amplifier thus replaced may be adapted so as to vary its gain with the gain value Grec supplied by the gain calculator 208C.

Further, the gain calculator 208C may be adapted to be operative with three or more magnification constants, in other words, with more fine steps of magnification constants such as δ40, δ41, δ42, δ43 and so on, if appropriate for the magnitude of a proximal noise as far as the gain calculator 208C is able to calculate gain values Grec appropriate for the proximal noise.

In operation, the proximal noise detector 209 receives the input transmitter noise signal 233 and compares the proximal noise level NLVL_S included in the proximal end signal 233 to the predetermined threshold TH_BG_S. If the proximal noise detector 209 determines when the relation (8) is satisfied, then the detector 209 decides that the proximal talker 30 is in the environment full of noise caused by the background noise source 40 to produce the enable signal BG_NZY on its output port 241 to the gain calculator 208C. Otherwise, the proximal noise detector 209 disables its output port 241 to output no effective signal.

While the gain calculator 208C receives the difference signal Dif_lev_r on its input 237 from the level transition detector 207, the gain calculator 208C responds to the presence or absence of the enable signal BG_NZY on its other input port 241 to calculate the gain Grec by means of the expressions (9) and (10). The variable-gain amplifier 13 in turn amplifies the input distal end signal 16 with the gain Grec provided on its input port 221 from the gain calculator 208C.

In summary, according to the present alternative embodiment, the telephone circuitry 10 includes the proximal noise detector 209, which is adapted for determining, from its input signal NLVL_S supplied from the transmitter level calculator 204, whether or not the proximal end signal 31 caught by the microphone 14 carries a noise signal component having its level exceeding the predetermined threshold. If such a noise signal component is detected, the proximal noise detector 209 allows the gain calculator 208C to render the variable-gain amplifier 13 to enhance its gain on the distal end signal 16.

Thus, the instant alternative embodiment is arranged such that the noise blocking effect caused by approaching the auricle 30 of the user to the loudspeaker 11 is presumed as not due to a decrease in level of the distal end voice but to an increase in level of the proximal background noise. The variable-gain amplifier 13 may thus be controlled to increase, when such an increase of the proximal background noise is detected, its gain to the rated value so as to facilitate the proximal listener 30 to clearly listen to the distal end voice.

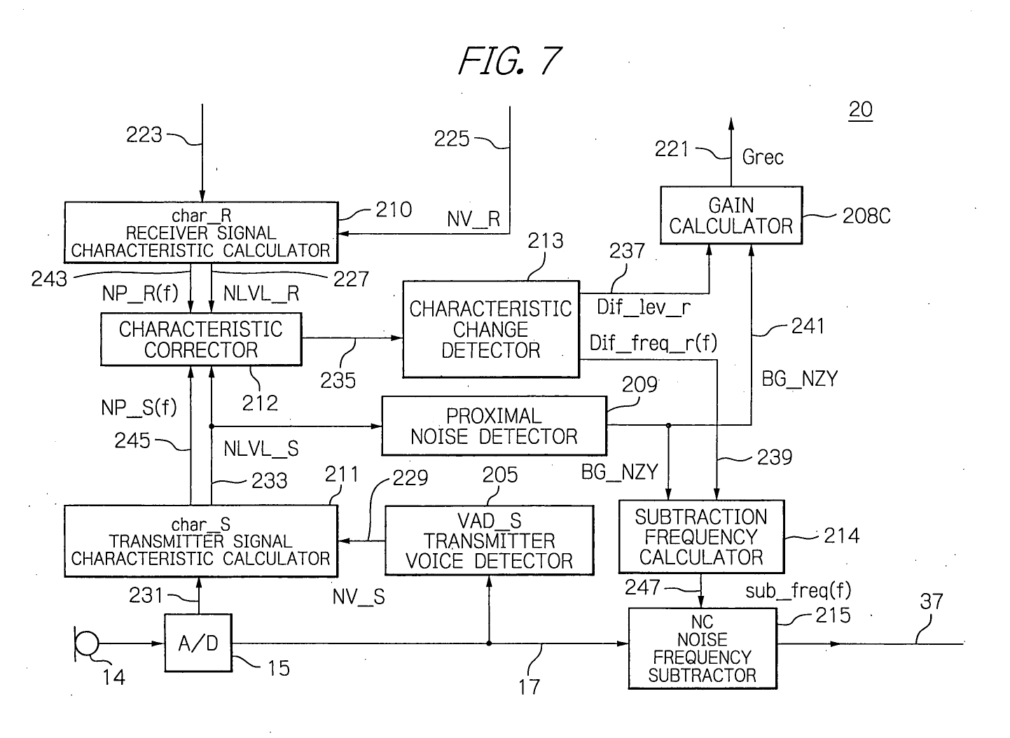

Well, with reference to FIG. 7, a further alternative embodiment of the telephone circuitry will be described in accordance with the invention. The instant alternative embodiment may be the same as the illustrative embodiment shown in and described with reference to FIG. 6 except that it includes a receiver signal characteristic calculator (char_R) 210, a transmitter signal characteristic calculator (char_S) 211, a characteristic corrector 212 and a characteristic change detector 213 in place of the receiver level calculator 203, transmitter level calculator 204, level corrector 206 and level transition detector 207, respectively, and additionally includes a subtraction frequency calculator 214 and a noise frequency subtractor (NC) 215.

More specifically, the receiver signal characteristic calculator 210 has its input port 223 interconnected to the A/D converter 203 and its control port 225 interconnected to the output from the receiver voice detector 202. The receiver signal characteristic calculator 210 is adapted to be operative in response to the enable signal 225 to determine the level of the signal 223, as done by the receiver level calculator 203, to produce the environmental sound level signal NLVL_R on its output port 227, which is in turn interconnected to one input port of the characteristic corrector 212.

Furthermore, the receiver characteristic calculator 210 is adapted to calculate, or extract, the characteristic NP_R(f) of the input signal 223, and hence the environmental sound captured as a background noise by the loudspeaker 11. The calculation of the characteristics may be done by means of, for example, the Fast Fourier Transform (FFT) known per se. The receiver signal characteristic calculator 210 has its other output port 243 interconnected to another input port of the characteristic corrector 212.

The transmitter signal characteristic calculator 211 has its input port 231 interconnected to the A/D converter 15 and its control port 229 interconnected to the output from the transmitter voice detector 205. The transmitter signal characteristic calculator 211 is adapted to be operative in response to the enable signal 229 to determine the level of the signal 231, as done by the transmitter level calculator 204, to produce the background noise level signal NLVL_S on its output port 233, which is in turn interconnected to still another input of the characteristic corrector 212 and an input port of the proximal noise detector 209.

Moreover, the transmitter characteristic calculator 211 is adapted to calculate, i.e. extract, the characteristic NP_S(f) of the input signal 231, and hence the background noise captured by the microphone 14. The calculation of the characteristics may also be done by means of the Fast Fourier Transform, for example. The transmitter signal characteristic calculator 211 has its other output port 245 interconnected to still another input port of the characteristic corrector 212.

The characteristic corrector 212 is adapted for correcting the noise level signals NLVL_R and NLVL_S input on its input ports 227 and 233, respectively, to output resultant signals on its output 235 to the change detector 213, as done by the level corrector 206.

The characteristic corrector 212 is also adapted for correcting the signals representative of the frequency characteristics NP_R(f) and NP_S(f) input on its other input ports 243 and 245, respectively, to develop resultant signals also on its output 235 to the change detector 213. Like the characteristic corrector 212 correcting the signal levels NLVL_R and NLVL_S, the characteristic corrector 212 also corrects the receiver frequency characteristic signal NP_R(f) so as to substantially be equal in power to the transmitter frequency characteristic signal NP_S(f).

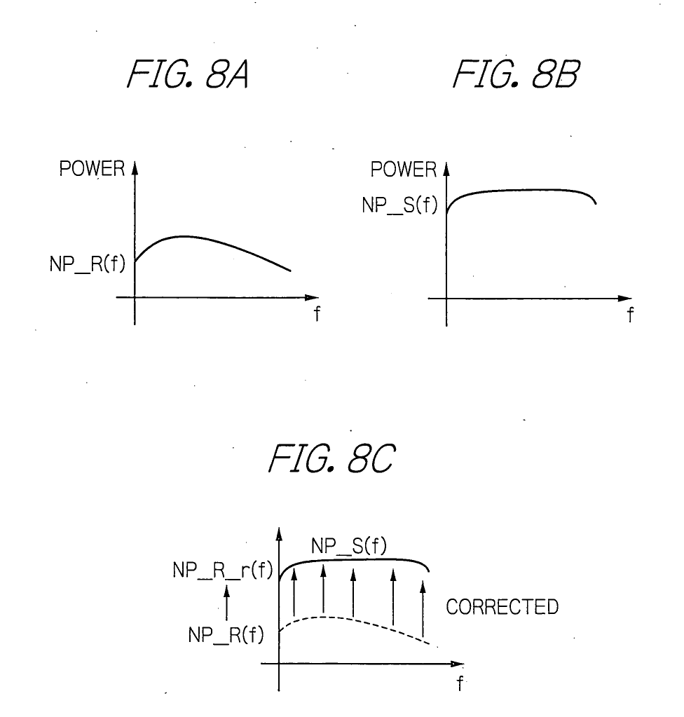

More specifically with reference to FIGS. 8A and 8B, the electric power levels of the background noises NP_R(f) and NP_S(f) respectively provided from the receiver and transmitter signal characteristic calculators 210 and 211 are plotted with respect to the frequency f, in other words, the frequency characteristics of the background noises NP_R(f) and NP_S(f) are plotted, respectively. The characteristic corrector 212 corrects the receiver background noise NP_R(f) so as to be substantially comply with the transmitter background noise NP_S(f) to output a resultant signal NP_R_r(f), as shown in FIG. 8C, on its output 235 to the change detector 213.

In general, the microphone 14 is in its nature superior in sensitivity to sound to the loudspeaker 11 and thus the former has its frequency characteristics flatter than the latter. Such flatter frequency characteristics are more advantageous in processing a noise suppression on the output signal of the microphone 14 rather than the loudspeaker 11, as will be described. That is why the receiver frequency characteristic signal NP_R(f) is thus corrected rather than the transmitter frequency characteristic signal NP_S(f). However, the characteristic corrector 212 may be adapted to correct the transmitter background noise NP_S(f) so as to be substantially comply with the receiver background noise NP_R(f).

As describe earlier, the loudspeaker 11 is in its nature inferior in capability of transducing sound to electric signals to the microphone 14, which is dedicated to the acousto-electric conversion. The characteristic corrector 212 is thus adapted for correcting such a difference in acousto-electric conversion between the loudspeaker 11 and microphone 14. Specifically, the characteristic corrector 212 is adapted for once correcting the receiver background noise characteristic NP_R(f) so as to substantially be consistent with the transmitter background noise characteristic NP_S(f) and thence calculating the value of a coefficient for correction, e.g. NP_S(f)/NP_R(f), to hold the coefficient value, which will thereafter be applied whenever correcting the receiver noise characteristic NP_R(f).

Alternatively, the value of the coefficient for correction may be determined in advance, taking account of the difference in acousto-electric conversion property between the loudspeaker 11 and microphone 14 when designing the telephone circuitry 10, and stored in a storage, not shown, of the characteristic corrector 212.

The characteristic change detector 213 is adapted to thus receive the corrected signal 235 from the characteristic corrector 212 to detect a change in frequency characteristics caused by the noise blocking effect with the auricle 30. The noise blocking effect from the auricle 30 may lower not only the noise level per se but also the power level in frequency characteristics of the background noise. With the instant alternative embodiment, the noise blocking effect may be detected in the manner as described with reference to FIG. 1 as well as by detecting a change in frequency characteristics of the background noise.

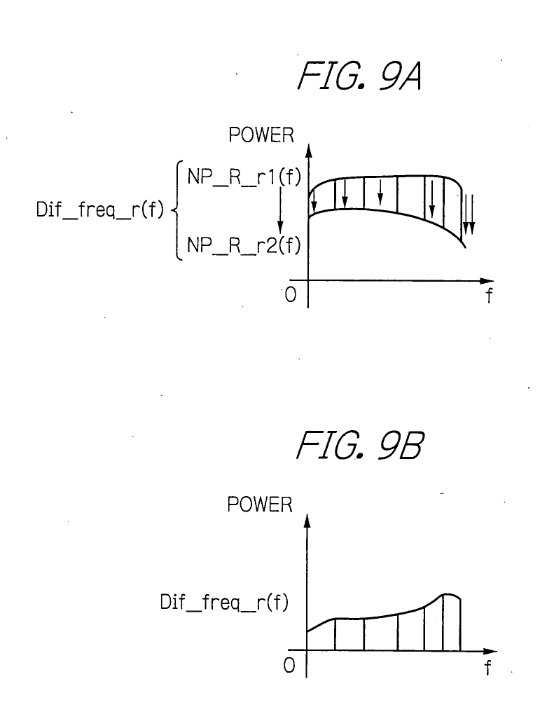

Specifically, reference will be made to FIGS. 9A and 9B. When no noise blocking effect is detected, the characteristic change detector 213 determines the frequency characteristic as plotted with a curve NP_R_r1(f). When the noise blocking effect is detected, the characteristic change detector 213 determines the frequency characteristic as plotted with another curve NP_R_r2(f), which has been dropped from the former by a difference Dif_freq_r(f), as seen from FIG. 9A. The difference Dif_freq_r(f) is plotted in FIG. 9B with respect to the frequency f.

The characteristic change detector 213 detects an abrupt drop in level of the input signal 235 coming from the receiver level calculator 203 to thereby determine the noise blocking effect caused, as with the level transition detector 207 of the illustrative embodiment shown in and described with reference to FIG. 1. The characteristic change detector 213 outputs the resultant value of level difference Dif_lev_r on its one output 237 to the gain calculator 208C.

At that time, the frequency characteristic drops in power from the curve NP_R_r1(f) to the other curve NP_R_r2(f) as shown in FIG. 9A. That may be caused by the auricle 30 partly or completely having blocked the microphone 11 from the background noise emanated from the background noise source 40.

The characteristic change detector 213 calculates the frequency characteristics NP_R_r1(f) and NP_R_r2(f) by means of the following expression (12) to obtain the difference, or power drop, Dif_freq_r(f), from NP_R_r1(f) to NP_R_r2(f).

Dif_{—}freq_{—}r(f)=NP_{—}R_{—}r1(f)−NP_{—}R_{—}r2(f). (12)

Note that the expression may be replaced in use by

Dif_{—}freq_{—}r(f)=NP_{—}R1(f)−NP_{—}R2(f). (12-1)

The characteristic change detector 213 has its other output 239 interconnected to one input of the subtraction frequency calculator 214 to produce a signal representative of the difference Dif_freq_r(f) on the output 239 to the noise frequency subtractor 215.

The output 241 of the proximal noise detector 209 is also interconnected to the other input of the subtraction frequency calculator 214, in addition to the input of the gain calculator 208C. Thus, the subtraction frequency calculator 214 receives the enable signal BG_NZY whenever the significant proximal noise is detected by the proximal noise detector 209 and otherwise no effective signal on the other input port 241.

The subtraction frequency calculator 214 is operative in response to such a control signal 241, or BG_NZY, to receive the characteristic difference signal 239, or Dif_freq_r(f), to calculate a noise subtraction frequency component Sub_freq(f) in accordance with expressions

Sub_{—}freq(f)=C51Dif_{—}freq_{—}r(f),

where no BG_NZY, (13)

Sub_{—}freq(f)=C52Dif_{—}freq_{—}r(f),

where BG_NZY enabled, (14)

where coefficients C51 and C51 take values between null and unity, inclusive. The larger the coefficients, the more effective the noise suppression and the more distorted in sound quality due to the frequency subtraction, and vice versa. With the present alternative embodiment, the coefficients C51 and C52 may be equal to 0.2 and 0.9, respectively, but may not be restrictive, of course. In order to more effectively suppress a stronger noise, it is advantageous to set C52≧C51.

Alternatively, the coefficient, e.g. C51, in the expression (13) may be designed to be variable in response to the magnitude of the proximal noise level signal NLVL_S, without using the other expression (14). So far as the subtraction frequency calculator 214 is designed such as to be capable of calculating the noise subtraction frequency component, or power drop, Sub_freq(f) of the frequency characteristic associated with the proximal noise level NLVL_S, how to calculate the power drop may not specifically be restricted to what was described above.

The subtraction frequency calculator 214 has its output port 247 interconnected to an input port of the frequency subtractor 215, the output port 247 developing the power drop Sub_freq(f) thus calculated. The frequency subtractor 215 is adapted for subtracting the power drop Sub_freq(f) from the proximal end signal 17, which is supplied from the A/D converter 15 and possibly contains the background noise irradiated from the background noise source 40.

The frequency subtractor 215 may be adapted for subtracting a frequency component by means of a known solution, for example, what is disclosed by Tokuda indicated earlier in the introductory portion of the present specification, and then inversely transforming the resultant signal in frequency domain to the time-domain signal by means of the inverse FFT. The resultant time-domain signal will be transmitted over a connection 37 toward the distal end user, i.e. listener. The frequency subtractor 215 may be implemented by comprising a filter bank or an adaptive filter, and not restrictive to the solution taught by Tokuda.

In operation, when the receiver voice detector 202 detects no voice signal component in the input distal end signal 19, the receiver voice detector 202 develops on its output 225 an enable signal NV_R indicative of the absence of voice signal component to the control input of the receiver signal characteristic calculator 210. The receiver signal characteristic calculator 210, when thus primed with the enable signal NV_R, calculates the signal level NLVL_R and frequency characteristic NP_R(f) of the signal 223 coming from the loudspeaker 11 via the A/D converter 201. The resultant signals 227 and 243 indicative of the level NLVL_R and NP_R(f) thus calculated are forwarded to the characteristic corrector 212.

When the transmitter voice detector 205 detects no voice signal component in the proximal end signal 17, the detector 205 enables its output 229 to output the enable signal NV_S representing the absence of voice signal component to the control input of the transmitter signal characteristic calculator 211. The transmitter signal characteristic calculator 211, when thus primed, calculates the signal level NLVL_S and the frequency characteristic NP_S(f) of the proximal end signal 31, FIG. 1, from the digital signal 231 to produce the signals NLVL_S and NP_S(f) representing the signal level and frequency characteristic thus calculated to the inputs 233 and 245 of the characteristic corrector 212, respectively.

The characteristic corrector 212 thus receives the signals NLVL_R and NP_R(f) from the receiver signal characteristic calculator 210 as well as the signals NLVL_S and NP_S(f) from the transmitter signal characteristic calculator 211, and corrects the signal level and characteristic NLVL_R and NP_R(f) of the receiver signal to deliver resultant signals NLVL_R_r and NP_R_r(f) thus corrected together with the transmitter signals NLVL_S and NP_S(f) to the characteristic change detector 213.

The characteristic change detector 213, when having received the signals NLVL_R_r and NP_R_r(f), and NLVL_S and NP_S(f) to test therewith the relations (4) and (5) stated earlier. When the relation (4) is satisfied without maintaining the relation (5), which means the loudspeaker 11 is subjected to the noise blocking effect exceeding the predetermined threshold, the change detector 213 uses the relation (6) to derive the degree of the noise blocking effect, i.e. to calculate the level drop Dif_lev_r. Otherwise, the characteristic change detector 213 sets the level drop signal Dif_lev_r to 0 dB, i.e. disables the signal 237. The resultant signal 237 will in turn be supplied to the gain calculator 208C.

Furthermore, when the relation (4) is satisfied without maintaining the relation (5), as described above, the change detector 213 uses the relation (12) to calculate the characteristic change Dif_freq_r(f) to provide the resultant signal 239 to the subtraction frequency calculator 214.

The proximal noise detector 209 is responsive to the input transmitter noise signal 233, and, if the relation (8) is satisfied, which means that the proximal talker 30 is in the environment full of noise exceeding the predetermined threshold, then the proximal noise detector 209 produces the enable signal BG_NZY on its output port 241 to the gain calculator 208C. Otherwise, the proximal noise detector 209 disables its output port 241 to output no effective signal.

The gain calculator 208C receives the difference signal Dif_lev_r on its input 237 from the level transition detector 207. The calculator 208C responds to the presence or absence of the enable signal BG_NZY on its other input port 241 to calculate the gain Grec by means of the expressions (9) and (10). The variable-gain amplifier 13 in turn amplifies the input distal end signal 16 with the gain Grec thus provided on its input port 221 from the gain calculator 208C.

The subtraction frequency calculator 214 is responsive to the control signal BG_NZY on its one input 241 to receive the characteristic difference signal Dif_freq_r(f) on its other input 239 to calculate a noise subtraction frequency component Sub_freq(f) by means of the expression (13) or (14) dependent upon whether or not the control signal BG_NZY is enabled, respectively. The frequency subtractor 215 receives on its input port 247 the power drop signal Sub_freq(f) thus calculated to subtract the power drop Sub_freq(f) from the proximal end signal 17 received from the A/D converter 15 to transmit the resultant proximal end signal 37 toward the distal end user.

In summary, the present alternative embodiment is adapted by taking account of improving the sound quality of the proximal end signal to be transmitted to the distal end listener. For that aim, with the alternative embodiment, a difference Dif_freq_r(f) in frequency characteristic NP_R_r, or NP_R_r(f) corrected, is obtained between when the noise blocking effect is caused and when no such effect is caused to regard the difference as a result from the frequency characteristics of the background noise caused by the background noise source 40 to derive the noise subtraction frequency component Sub_freq(f) by the subtraction frequency calculator 214 from the difference signal Dif_freq_r(f), and to subtract the noise subtraction frequency component Sub_freq(f) from the proximal end signal 17 to transmit the resultant proximal end signal 37 toward the distal end user. The proximal end signal 37 to be transmitted is thereby substantially free from the background noise caused by the background noise source 40.

The subtraction frequency calculator 214 is adapted to respond to the presence or absence of the enable signal BG_NZY representing when the background noise is significantly strong and provided from the proximal noise detector 209 to multiply the characteristic difference signal Dif_freq_r(f) by the coefficient which may fall between null and unity, inclusive. Specifically, when the enable signal BG_NZY is provided, a larger value is selected as the coefficient so as to render the frequency component subtraction more effective, whereas, when the enable signal BG_NZY is disabled, a smaller value is selected as the coefficient so as to render the frequency component subtraction less effective, resulting in allowing the distal end listener to more naturally enjoy the sound quality of the proximal end signal, when transmitted thereto.

A particular importance among the features described above is placed on the feature of utilizing, directly or by means of a simple coefficient, a change component in power of the frequency characteristic, i.e. Dif_freq_r(f), per se for the subtraction characteristic for use in subtracting the frequency component substantially corresponding to the background noise. Conventionally, as taught by Tokuda stated above, a solution commonly used for noise reduction relying upon the frequency subtraction is to analyze an incoming signal to finely discriminate voiced sections from noise sections, of which the frequency components are calculated to be subtracted from the incoming signal.

That conventional noise reduction relying upon the frequency subtraction suffers for many decades from the difficulty in defining noise sections, thus raising the problem of failing to prevent sound quality from being deteriorated. Unfortunately, the problem is naturally raised to a certain extent and would remain unsolved also in the future because the noise reduction relying upon the frequency subtraction essentially requires the availability of discriminating the voiced signal from the unvoiced signal, namely, the property of a purely noisy section, in order to attain the quality of noise suppression. Awkwardly, however, so far as a sound signal carrying a heavy noise to the extent that the noise suppression has to be applied is used to determine a purely noisy section and then be utilized for the noise reduction processing following thereto, error must necessarily be involved more or less in determining a noise section from a voiced section. The conventional noise suppression thus necessarily involves an erroneous production of a noise subtraction component based upon the result from the erroneous detection of a noise section. Such an erroneous production of a noise subtraction component naturally leads to excessively or insufficiently subtract the subtraction component, giving rise to deteriorating the sound quality of the sound signal.

By contrast, according to the current alternative embodiment, the presence of a noise component is determined by taking account of detecting a change in signal caused by the auricle of the listener having approached or made into contact with the telephone handset, rather than analyzing the voice signal component per se. More generally, when the input means of the telephone handset is covered with or blocked by something, the effect of the coverage or blocking is simulated into the appropriate effect on the signal to be transmitted to the distal end. The frequency component that may be blocked during conversation on the phone could be estimated as a background noise around the proximal end listener, which noise would otherwise be transmitted from the microphone 14 toward the listener on a distal end terminal, and is thus desirably to be removed from the signal to be transmitted. Such a background noise component may be removed by the frequency subtraction, for example, and is thus not so critical for accuracy in timing as required by the signal section detection.

From the viewpoint of voice detector function provided, the instant alternative embodiment has the transmitter and receiver voice detectors 205 and 202, which are become inferior in accuracy of voice detection when a proximal noise component is detected. Under such a circumstance, however, both microphone 14 and loudspeaker 11 catch the noise as well as voice, resulting in the characteristic corrector 212 appropriately correcting the frequency components without causing any disadvantages. This is followed by simply dealing with the drop in frequency component as a difference, so that the subtraction frequency calculator 214 is hardly affected thereby.

The instant alternative embodiment thus structured implements a telephone terminal unit which serves as stably removing noise, regardless of however the signal-to-noise ratio (S/N) of the voice of the proximal talker to the background noise around the talker is, so as for the distal end listener to listen to the transmitted sound with more natural sound quality.

The telephone circuitry 20 in accordance with the alternative embodiment has its loudspeaker 11 serve also as acousto-electric transducer, from which the signal level NLVL_R and signal characteristic NP_R(f) of the receiver background signal are obtained and utilized for suppressing the noise on the proximal end signal 17. This eliminates a microphone otherwise dedicatedly arranged in the vicinity of the loudspeaker for capturing such a background noise, as required by the telephone subscriber set taught in U.S. Pat. No. 5,748,725 to Kubo, thereby accomplishing a simpler structure of the telephone circuitry.

Moreover, in accordance with the instant alternative embodiment, the telephone circuitry 20 has the characteristic change detector 213 and the subtraction frequency calculator 214 producing the noise subtraction frequency component Sub_freq(f), which is, when once derived, fixed as a frequency component of the background noise caused by the background noise source 40 to be used thereafter by the frequency noise subtractor 215 for suppressing the proximal noise component. This eliminates a continuous feeding back for noise suppression or cancelling, as required by the telephone subscriber set taught in Kubo, thus resulting in reducing the amount of processing for noise suppression. Such reduction may lead to, e.g. downsizing the entire system, and hence its costs.

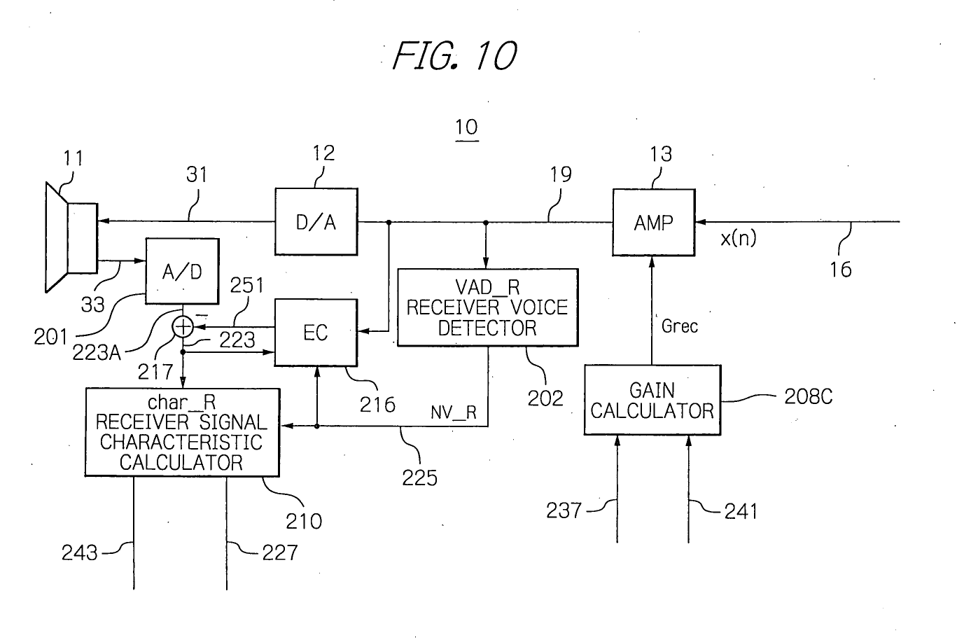

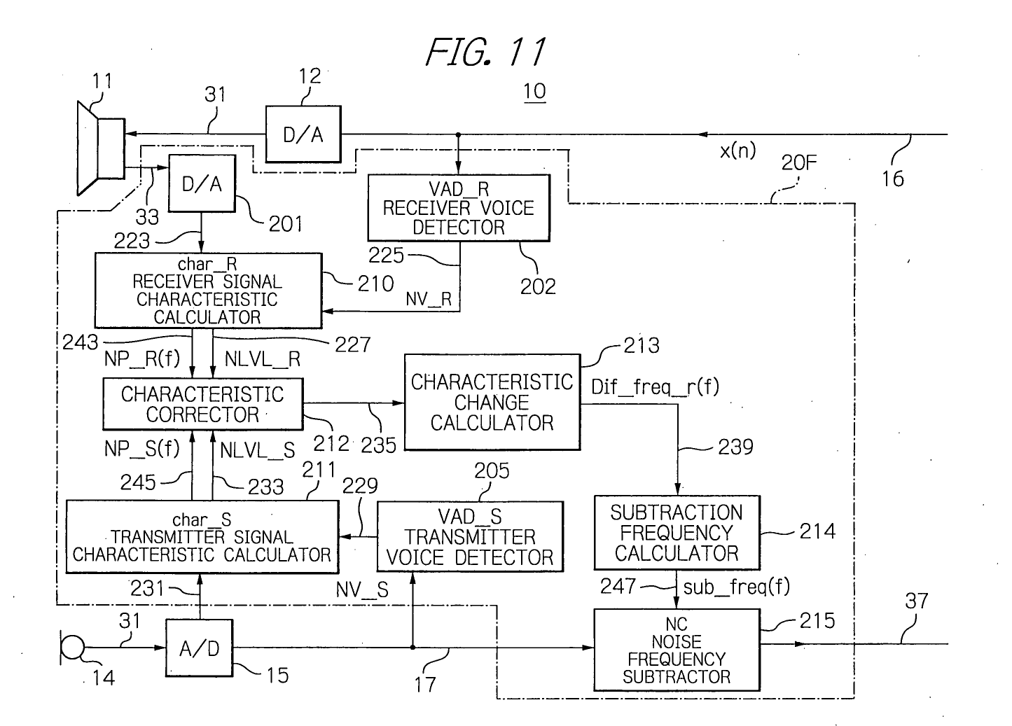

Well, reference will be made to FIG. 10, showing a still further alternative embodiment of the telephone circuit 10, which may be the same as the alternative embodiment shown in and described with reference to FIG. 7 except that the instant alternative embodiment includes an echo canceller (EC) 216 and a suppressor adder 217 with the receiver voice detector 202, FIG. 1, having its input port interconnected to the connection 19 extending from the variable-gain amplifier 13 to the D/A converter 12.

The suppressor adder 217 has its one input port interconnected to the digital output 223A and its other, i.e. inverted, input port (−) 251 interconnected to the output of the echo canceller 216. The adder 217 has its output port interconnected to the input port 223 of the receiver characteristic calculator 210 and also to one input port of the echo canceller 216. The echo canceller 216 has its other input port interconnected to the connection 19 extending from the variable-gain amplifier 13 to the D/A converter 12 and its further input port interconnected to the output port 225 of the receiver voice detector 202.

With the illustrative embodiment shown in and described with reference to FIG. 6, when the distal end signal 16 contains a larger noise component, the loudspeaker 11 possibly emits the sound caused by the larger distal end noise component and may catch the sound of the distal end noise component to produce it in the form of echo on its output 33. Such an echo would cause the sound signal adjuster 20 to erroneously operate.

The instant alternative embodiment aims at reducing the frequency of the erroneous operation of the sound signal adjuster 20 by suppressing or cancelling such an echo by means of the echo canceller 216 and suppressor adder 217 thus provided.

More specifically, the echo canceller 216 includes an adaptive filter, not shown. The echo canceller 216, when the signal NV_R is disabled by the receiver voice detector 202 to represent a voice signal component conveyed by the distal end signal 16, is primed with the input signal 225 to render the adaptive filter operative in response to the signals provided on its input 223 from the adder 217 and from the input of the A/D converter 201 to adaptively operate to produce such an output 251 to the adder 217 that the adder 217 minimizes its output 223 in power.

The adder 217 adds the output 223A of the receiver A/D converter 201 to the inverted output 231 of the echo canceller 216, in other words, subtracts the former from the latter, to thereby cancel the echo included in the noise signal 33. The adder 217 may be referred to as a subtractor in this sense. The signal 233 output from the adder 217 will be fed back to the echo canceller 216 and also input to the receiver characteristic calculator 210. To the adaptive filter, any adaptive filtering algorithms may be applied, such as the Normalized Least Mean Square (NLMS) or the Least Mean Square (LMS) algorithm, which are known per se, whatsoever the output of the adder 217 can be minimized by.

The echo canceller 216, when the signal NV_R is enabled on its input port 225, which means no voice signal component is involved in the distal end signal 16, disables the adaptive filtering algorithm of the adaptive filter with its filter coefficients fixed to the value determined while the voice signal component was detected. In turn, the adaptive filter of the echo canceller 216 is operative in response to the signals provided from the output of the variable-gain amplifier 13 and on its input 223 from the adder 217 to accordingly produce the output 251 to the adder 217. The output 223 of the adder 217 is also supplied to the receiver characteristic calculator 210.

In operation, when the receiver voice detector 202 determines a voice signal component conveyed by the distal end signal 16, it disables the signal NV_R to prime the echo canceller 216 with the input signal 225 to render the adaptive filter operative. The echo canceller 216 in turn adaptively operates to substantially cancel the noise component from the signal on the output 223A of the receiver A/D converter 201 in cooperative with the suppressor adder 217, thus cancelling the echo caused by the fed-back noise and included in the noise signal 33. The distal end signal 19 output from the variable-gain amplifier 13 and conveying no voice signal component is transferred via the D/A converter 12 to the loudspeaker 11, as different from the illustrative embodiment shown in and described with reference to FIG. 5.

In the current alternative embodiment, the receiver characteristic calculator 210 may be replaced with the receiver level calculator 203, FIG. 1, and the remaining constituent components replaced accordingly, as shown in FIG. 1 or 6. Further in the current alternative embodiment, the gain calculator 208C may be replaced with the gain calculator 208, FIG. 6, and the remaining constituent components replaced accordingly, as shown in FIG. 1.

With the illustrative embodiment shown in and described with reference to FIG. 5, when no voice signal component is included in the distal end signal 16, as described above, the receiver voice detector 202B blocks the distal end signal 16 from being output to the loudspeaker 11. If the distal end talker is involved in a worse noise environment so as for the distal end signal 16 to contain a heavier sound noise component, the voice detector 202B may so frequently block the distal end signal 16 as to bother the proximal end listener 30. On the other hand, for the receiver characteristic calculator 210, it would not be preferable to receive an echo caused by the distal end noise component fed back thereto by the loudspeaker 11 to disturb its characteristic calculation.

Taking those circumstances into account, the instant alternative embodiment includes the echo canceller 216. When a voice signal component is carried by the distal end signal 16, the echo canceller 216 identifies the characteristic of the loop-back path by the adaptive filtering algorithm such as the NLMS. When no voice signal component is carried by the distal end signal 16, the echo canceller 216 fixes the coefficients of the adaptive filter to the value thus identified. On the input port 223, then, the echo canceller 216 receives the signal including the signal resultant from adding by the adder 217 the noise component coming from the distal end to the noise component fed back from the loudspeaker 11. In this condition, the coefficient of the adaptive filter is fixed to the value already identified, so that the fixed coefficient is used to produce a replica signal for the looped-back noise. Consequently, the adder 217 will cancel the distal end noise with the replica of the looped-back distal end noise, thereby providing the receiver characteristic calculator 210 purely with the proximal background noise, as intended, for use in the following steps.

In general, the quality of sound may often be felt in dependent upon individuals. In fact, when listening to noisy sound signals from the distal end, many listeners may relatively prefer to listen to the noisy, but continuous and natural, sound rather than to the frequently or unexpectedly interrupted sound. That fact is taken into account to implement the instant alternative embodiment, shown in and described with reference to FIG. 10, which does not interrupt the distal end signal 16 as done with the embodiment shown in FIG. 5 but makes the talker and listener enjoy a more comfortable conversation on the phone.

Finally, still another alternative embodiment of the telephone circuitry will be described with reference to FIG. 11, in which the sound signal adjuster 20F includes only the constituent components required for reducing a noise signal component caused by the distal end and looped back on the proximal end signal.

As seen from FIG. 11, the sound signal adjuster 20F of the alternative embodiment includes the A/D converter 201, receiver voice detector 202, receiver signal characteristic calculator 210, transmitter voice detector 205, transmitter signal characteristic calculator 211, characteristic corrector 212, noise frequency subtractor 215, characteristic change detector 213 and subtraction frequency calculator 214, which are interconnected as illustrated and described above. The telephone circuitry 10 of the alternative embodiment lacks a constituent element corresponding to the variable-gain amplifier 13. Accordingly, the sound adjuster 20F lacks constituent elements corresponding to the gain calculator 208C and proximal noise detector 209 as well as the echo canceller 216 and suppressor adder 217, and functions associated therewith.

That configuration may not be restrictive. For example, the variable-gain amplifier 13 may however be provided. The receiver voice detector 202 may be substituted by the receiver voice detector 202B shown in and described with reference to FIG. 5. Furthermore, the echo canceller 216 and adder 217 may be arranged in the sound adjuster 20F.

With the present alternative embodiment the characteristic detector 213 may be adapted for calculating the difference of the frequency characteristic Dif_freq_r(f) only and not the level difference Dif_lev_r because of no constituent components corresponding to the gain calculator 208 or 208C provided.

Correspondingly, the subtraction frequency calculator 214 may be adapted to use only the difference characteristic Dif_freq_r(f) to obtain the noise subtraction frequency component Sub_freq(f) and not to use the enable signal BG_NZY representing a proximal noise detected. In this respect, with the illustrative embodiment shown in FIG. 7, the subtraction frequency calculator 214 is operative in response solely to the absence or presence of the enable signal BG_NZY to thereby select the appropriate coefficient C51 or C52 for use in the expression (13) or (14). With the instant alternative embodiment, however, the coefficient for use in determining the noise subtraction frequency component may be fixed to an appropriate value, such as C51 or C52, or any other suitable value.

The alternative embodiment shown in FIG. 11 may include the proximal noise detector 209, FIG. 7, so as to allow the subtraction frequency calculator 214 to calculate the noise subtraction frequency component Sub_freq(f) by means of the expressions (13) and (14), as done with the illustrative embodiment shown in FIG. 7. In that case, the substitution frequency calculator 214 may be adapted, as with the illustrative embodiment shown in FIG. 7, to respond also to the presence or absence of the enable signal BG_NZY to calculate the noise subtraction frequency component Sub_freq(f). Note that, so far as the noise subtraction frequency component Sub_freq(f) can be derived, the use of the expressions (13) and/or (14) may not be restrictive but any appropriate calculation methods are applicable. For instance, the coefficient, such as C51, in the expression (13) may be set to be variable in dependent upon the magnitude of the proximal noise level signal NLVL_S, without using the other expression (14).

In operation, when the receiver voice detector 202 detects no voice signal component in the input distal end signal 19, the receiver voice detector 202 produces on its output 225 an enable signal NV_R indicative of the absence of voice signal component to the control input of the receiver signal characteristic calculator 210. The receiver signal characteristic calculator 210, while thus primed with the enable signal NV_R, calculates the signal level NLVL_R and frequency characteristic NP_R(f) of the signal 223 coming from the loudspeaker 11 via the A/D converter 201. The resultant signals 227 and 243 indicative of the level NLVL_R and NP_R(f) thus calculated are forwarded to the characteristic corrector 212.

When the transmitter voice detector 205 fails to detect a voice signal component in the proximal end signal 17, the detector 205 enables its output 229 to output the enable signal NV_S representing the absence of voice signal component to the control input of the transmitter signal characteristic calculator 211. The transmitter signal characteristic calculator 211, when thus primed, calculates the signal level NLVL_S and the frequency characteristic NP_S(f) of the proximal end signal 31 from the digital signal 231 to produce the signals NLVL_S and NP_S(f) representing the signal level and frequency characteristic thus calculated to the inputs 233 and 245 of the characteristic corrector 212, respectively.

When the characteristic corrector 212 receives the signals NLVL_R and NP_R(f) from the receiver signal characteristic calculator 210 as well as the signals NLVL_S and NP_S(f) from the transmitter signal characteristic calculator 211, the calculator 212 corrects the signal level and characteristic NLVL_R and NP_R(f) of the receiver signal to supply the characteristic change detector 213 with resultant signals NLVL_R_r and NP_R_r(f) thus corrected together with the transmitter signals NLVL_S and NP_S(f).

When the characteristic change detector 213 receives the signals NLVL_R_r and NP_R_r(f), and NLVL_S and NP_S(f), and determines that the relation (4) is satisfied without maintaining the relation (5), which means the loudspeaker 11 is subjected to the noise blocking effect exceeding the predetermined threshold, the change detector 213 uses the relation (12) to calculate the characteristic change Dif_freq_r(f), which will in turn be delivered from its output port 237 to the subtraction frequency calculator 214.

Then, the subtraction frequency calculator 214 receives the characteristic difference signal Dif_freq_r(f) on its other input 239 to calculate a noise subtraction frequency component Sub_freq(f), which is received by the frequency subtractor 215 on its input port 247. The frequency subtractor 215 subtracts the power drop signal Sub_freq(f) thus calculated from the proximal end signal 17 received from the A/D converter 15 to transmit the resultant proximal end signal 37 toward the distal end user.

The present alternative embodiment enjoys the advantages on reducing the proximal noise attained by the illustrative embodiment shown in and described with reference to FIG. 7.

The illustrative embodiments shown and described above are directed to the mobile telephone terminals. The present invention is of course applicable also to terminal devices for use in any other types of telecommunications system, such as walkie-talkies, or handheld transceivers, and land-line telephone subscriber sets.

The entire disclosure of Japanese patent application No. 2009-8053 filed on Jan. 16, 2009, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A sound signal adjuster for use in telephone circuitry comprising a microphone for capturing sound to produce a first sound signal and a loudspeaker for reproducing sound represented by a distal end signal transmitted from a distal end to the telephone circuitry, comprising:
a first circuit for obtaining a second sound signal representative of a sound in a vicinity of the loudspeaker;
a second circuit operative in response to the first sound signal and the second sound signal for determining whether or not the sound in the vicinity of the loudspeaker is at least partially blocked;
a first frequency characteristic extractor for extracting a frequency characteristic of the second sound signal, said first frequency characteristic extractor extracting a first frequency characteristic in response to said second circuit determining that the sound captured by the loudspeaker is at least partially blocked and a second frequency characteristic in response to said second circuit determining that the sound captured by the loudspeaker is substantially not blocked;
a difference calculator for calculating a difference in frequency characteristic between the first and second frequency characteristics; and
a third circuit for suppressing a noise component included in the first sound signal by means of the difference in frequency characteristic to transmit a first resultant signal to the distal end.

2. The sound signal adjuster in accordance with claim 1, wherein said first circuit obtains the second sound signal from the loudspeaker, the second sound signal being representative of the sound captured by the loudspeaker.

3. The sound signal adjuster in accordance with claim 1, further comprising a signal corrector for correcting at least either one of the first and second sound signals to compensate for a difference in sound capturing capability between said first circuit and the microphone to output a second resultant signal,
said second circuit using the second resultant signal to determine whether or not the sound in the vicinity of the loudspeaker is at least partially blocked.

4. The sound signal adjuster in accordance with claim 1, further comprising:
a second frequency characteristic extractor for extracting a frequency characteristic of the first sound signal; and
a frequency characteristic corrector for correcting the frequency characteristic of the first sound signal extracted and the frequency characteristic of the second sound signal extracted to compensate for a difference in sound capturing capability between said first circuit and the microphone to output a second resultant signal,
said third circuit using the second resultant signal to suppress the noise component.

5. The sound signal adjuster in accordance with claim 1, further comprising:
a distal end voice detector for detecting whether or not the distal end signal includes a voice signal component; and
a proximal end voice detector for, detecting whether or not the first sound signal contains a voice signal component,
said second circuit being responsive to said distal end voice detector substantially detecting no voice signal component in the distal end signal when said proximal end voice detector substantially detects no voice signal component in the first sound signal to determine that the sound in the vicinity of the loudspeaker is at least partially blocked to output a third resultant signal.

6. The sound signal adjuster in accordance with claim 5, further comprising a circuit operative in response to the third resultant signal for preventing the distal end signal from being supplied to the loudspeaker.

7. The sound signal adjuster in accordance with claim 1, wherein the sound reproduced by the loudspeaker is caught by said first circuit as an echo component, said sound signal adjuster further comprising an echo canceller for substantially cancelling the echo component from the second sound signal.

8. The sound signal adjuster in accordance with claim 5, further comprising a noise detector operative in response to said distal end voice detector substantially detecting no voice signal component in the distal end signal when said proximal end voice detector substantially detects no voice signal component in the first sound signal for detecting a noise component in level in the first or second sound signal to output a fourth resultant signal representative of an amount of the noise component,
said third circuit being responsive to the difference in frequency characteristic and the fourth resultant signal to suppress the noise component included in the first sound signal.

9. A computer program for adjusting a sound signal in telephone circuitry which comprises a computer, a microphone for capturing sound to produce a first sound signal and a loudspeaker for reproducing sound represented by a distal end signal transmitted from a distal end to the telephone circuitry, said computer program, when installed in and executed on the computer, functioning as a sound signal adjuster comprising:
a first circuit for obtaining a second sound signal representative of a sound in a vicinity of the loudspeaker;
a second circuit operative in response to the first sound signal and the second sound signal for determining whether or not the sound in the vicinity of the loudspeaker is at least partially blocked;
a first frequency characteristic extractor for extracting a frequency characteristic of the second sound signal, said first frequency characteristic extractor extracting a first frequency characteristic in response to said second circuit determining that the sound captured by the loudspeaker is at least partially blocked and a second frequency characteristic in response to said second circuit determining that the sound captured by the loudspeaker is substantially not blocked;
a difference calculator for calculating a difference in frequency characteristic between the first and second frequency characteristics; and
a third circuit for suppressing a noise component included in the first sound signal by means of the difference in frequency characteristic to transmit a first resultant signal to the distal end.

10. A method of adjusting a sound signal in telephone circuitry comprising a microphone for capturing sound to produce a first sound signal and a loudspeaker for reproducing sound represented by a distal end signal transmitted from a distal end to the telephone circuitry, said method comprising the steps of controlling:
a first circuit to obtain a second sound signal representative of a sound in a vicinity of the loudspeaker;
a second circuit to be operative in response to the first sound signal and the second sound signal to determine whether or not the sound in the vicinity of the loudspeaker is at least partially blocked;
a first frequency characteristic extractor to extract a frequency characteristic of the second sound signal so that the first frequency characteristic extractor extracts a first frequency characteristic in response to the second circuit determining that the sound captured by the loudspeaker is at least partially blocked and a second frequency characteristic in response to the second circuit determining that the sound captured by the loudspeaker is substantially not blocked;
a difference calculator to calculate a difference in frequency characteristic between the first and second frequency characteristics; and
a third circuit to suppress a noise component included in the first sound signal by means of the difference infrequency characteristic to transmit a first resultant signal to the distal end.

11. A sound signal adjuster for use in telephone circuitry comprising a microphone for capturing sound to produce a first sound signal and a loudspeaker for reproducing sound represented by a distal end signal transmitted from a distal end to the telephone circuitry, comprising:
first means for obtaining a second sound signal representative of a sound in a vicinity of the loudspeaker;
second means operative in response to the first sound signal and the second sound signal for determining whether or not the sound in the vicinity of the loudspeaker is at least partially blocked;
first frequency characteristic extractor means for extracting a frequency characteristic of the second sound signal, said first frequency characteristic extractor means extracting a first frequency characteristic in response to said second means determining that the sound captured by the loudspeaker is at least partially blocked and a second frequency characteristic in response to said second means determining that the sound captured by the loudspeaker is substantially not blocked;
difference calculator means for calculating a difference in frequency characteristic between the first and second frequency characteristics; and
third means for suppressing a noise component included in the first sound signal by means of the difference infrequency characteristic to transmit a first resultant signal to the distal end.
